(19) United States
(12) Patent Application Publication
(10) Pub. No.: US 2025/0142216 A1
(43) Pub. Date: May 1, 2025

(54) SYSTEMS AND METHODS FOR ADJUSTING CAPTURE DIRECTION AND ZOOM OF A CAMERA BASED ON DETECTED GAZE

(71) Applicant: Adeia Imaging LLC, San Jose, CA (US)

(72) Inventors: Ning Xu, Irvine, CA (US); Tao Chen, Palo Alto, CA (US)

(21) Appl. No.: 18/498,691

(22) Filed: Oct. 31, 2023

(51) Int. Cl. H04N 23/695; G02B 27/01; H04N 23/60; H04N 23/61; H04N 23/69

(52) U.S. Cl. CPC H04N 23/695; G02B 27/0172; H04N 23/61; H04N 23/64; H04N 23/69

(57) ABSTRACT

Systems, methods, and apparatuses are described for causing a camera of a head-mounted computing device to capture a first video, the head-mounted computing device comprising a camera direction control element for controlling a capture direction of the camera, and a camera zoom control element for controlling zoom of the camera. One or more objects in the captured first video may be identified based on a detected gaze angle of a user wearing the head-mounted computing device. A target location in an environment may be determined, and based on such target location, the capture direction and zoom of the camera may be adjusted using the camera direction control element and the camera zoom control element, respectively. The camera may capture, based on the adjusted capture direction and the adjusted zoom of the camera, a second video using the camera of the head-mounted computing device.

### CROSS-REFERENCE TO RELATED APPLICATIONS

The disclosure of commonly owned application Ser. No. ______, filed Oct. 31, 2023 and entitled “SYSTEM AND METHOD FOR EXPANDING FIELD OF VIEW IN MULTI-CAMERA DEVICES USING MEMS SCANNING MIRRORS,” (Attorney docket no. 001504-1014-101) is hereby incorporated by reference herein in its entirety. In addition, the disclosure of commonly owned application Ser. No. ______, filed Oct. 31, 2023 and entitled “SYSTEM AND METHODS FOR ENHANCED AR TRACKING VIA ADAPTIVE MEMS SCANNING MIRRORS,” (Attorney docket no. 001504-1017-101) is hereby incorporated by reference herein in its entirety.

### BACKGROUND

This disclosure is directed to systems and methods for adjusting a capture direction and zoom of a camera based on a determined target location in an environment. For instance, such target location may be determined based on a gaze angle of a user wearing a head-mounted computing device.

### SUMMARY

When using a video camera, such as a video camera of a mobile device, to capture a video of an ongoing event with a large field of view, such as a soccer game, it can be a challenging and often frustrating experience for a user to operate and adjust the camera to capture a quality video that includes objects that the user is interested in. Indeed, it is likely that the concentration and attention required for capturing such a quality video will interfere with the user's ability to enjoy the event as it is occurring. For example, when capturing a video, the user often will look at a viewfinder of the camera, such as provided via a screen of the mobile device, to make sure that the video corresponds to what the user desires to capture, and the user may need to adjust other parameters, such as a zoom or magnification level of the camera, to ensure that an object of interest is sufficiently captured at an appropriate size and level of detail in the video.

In one approach, wearable cameras, such as a GoPro® camera or Snap® spectacles, can be attached to the user's head so that the camera's field of view will follow the direction that the user's head is facing. However, such an approach is deficient in that the wearable cameras maintain the same zoom level throughout the video capture, which may lead to a lower-quality video. In addition, in such an approach, tracking a head pose or orientation of the user's head may not accurately track the object of interest, particularly for fast-moving objects, such as a soccer ball during a soccer game. For example, in many cases, a user may keep his or head stationary while shifting his or her eye gaze, or the user's eye gaze direction may differ from a direction that his or her head is oriented, which the aforementioned approach fails to account for.

To help overcome these problems, systems, methods, and apparatuses are disclosed herein for causing a camera of a head-mounted computing device to capture a first video of an environment, wherein the head-mounted computing device comprises a camera direction control element for controlling a capture direction of the camera and a camera zoom control element for controlling zoom of the camera. The systems, methods, and apparatuses described herein may detect a gaze angle of a user wearing the head-mounted computing device, and identify, based on the gaze angle of the user, one or more objects in the captured first video, and determine, based on the identified one or more objects, a target location in the environment. The systems, methods, and apparatuses described herein may adjust the capture direction of the camera using the camera direction control element based on the determined target location in the environment, and adjust the zoom of the camera using the camera zoom control element based on the determined target location in the environment. The systems, methods, and apparatuses described herein may cause the camera to capture a second video using the camera of the head-mounted computing device, wherein the second video is captured based on the adjusted capture direction and the adjusted zoom of the camera.

Such aspects enable providing a computing device that is capable of automatically adjusting a zoom level and a capture direction of a camera as video is being captured by the camera, by analyzing the scene being captured and the gaze of the user, so that the user can capture a quality video of a satisfying life experience in a particular environment while at the same time fully enjoying his or her experience in the particular environment. For example, a light-weight camera may be mounted on a head-mounted computing device being worn by the user, to track the user's gaze (which is one of the best indicators of attention and intention of a user) while minimizing interference with the user's real-time enjoyment of the scene being captured. Such a camera may be configured to intelligently capture video in a manner that is rapidly responsive to the user's gaze and adaptive to the content being captured. Such aspects may use a combined analysis of a history of the user eye gaze (e.g., in recently captured frames of the video) over a certain period of time and the corresponding scene to determine desired parameters to adjust the camera to, to effortlessly capture the live experience from the user's viewpoint.

In some embodiments, the camera direction control element comprises a microelectromechanical systems (MEMS) scanning mirror, and adjusting the capture direction of the camera using the camera direction control element comprises modifying an orientation of the MEMS scanning mirror. In some embodiments, the camera zoom control element comprises a liquid lens, and adjusting the zoom of the camera using the camera zoom control element comprises applying an electrical signal to the liquid lens. Such light weight and compact-sized devices can be used to build a wearable video camera system that is rapidly responsive and thus usable for real-time control and adjustment of camera zoom level and camera capture direction. The eye-tracking results and corresponding scenes may be taken as input to determine the proper direction and zoom level for the video camera in real time.

In some embodiments, adjusting the capture direction of the camera using the camera direction control element is performed without receiving a direct user request to modify the camera direction, and adjusting the zoom of the camera using the camera zoom control element is performed without receiving a direct user request to modify the zoom of the camera.

In some embodiments, determining, based on the identified one or more objects, the target location in the environment comprises determining that the gaze angle indicates that a gaze of the user is directed at a particular object of the identified one or more objects over a plurality of frames of the first video, and identifying a location of the particular object as the target location.

In some embodiments, the systems, methods, and apparatuses provided herein may be further configured to determine a first rate at which the gaze of the user is changing while tracking the particular object over the plurality of frames, determine a projected location of the particular object in a next frame of the first video, and adjust the capture direction of the camera using the camera direction control element based on the determined target location in the environment by causing the capture direction of the camera to be adjusted at a second rate that is faster than the first rate based on the projected location.

In some embodiments, determining, based on the identified one or more objects, the target location in the environment comprises determining that the gaze angle indicates that a gaze of the user is directed at different objects of the identified one or more objects over a plurality of frames of the first video, and assigning a first weight to pixels of a first object of the different objects in a first frame of the plurality of frames. In some embodiments, determining, based on the identified one or more objects, the target location in the environment further comprises: assigning a second weight to pixels of a second object of the different objects in a second frame of the plurality of frames, wherein the second frame is more recently captured than the first frame, and the second weight is higher than the first weight; computing a weighted center point in the environment based on the gaze of the user over the plurality of frames of the first video, based on the first weight of the first frame and the second weight of the second frame; and identifying the weighted center point as the target location.

In some embodiments, the capture direction of the camera is initially set to correspond to the detected gaze angle, and the zoom of the camera is initially set to a predefined zoom level.

In some embodiments, the systems, methods, and apparatuses provided herein may be further configured to input, to a trained machine learning model, data comprising one or more detected gaze angles of the user over a plurality of frames of the first video and images corresponding to the plurality of frames of the first video; and receive as output from the trained machine learning model, based on the input to the trained machine learning model, a desired zoom of the camera and a desired capture direction of the camera. Adjusting the zoom of the camera may be performed based on the desired zoom of the camera, and adjusting the capture direction of the camera may be performed based on the desired capture direction of the camera.

In some embodiments, the head-mounted computing device further comprises a beam splitter, and the beam splitter may be used to cause an optical center of the camera to correspond to a position of an eye of the user, to enable determining the adjusted capture direction based on the detected gaze angle.

In some embodiments, adjusting the capture direction of the camera further comprises determining an intersection point of respective viewing directions of the eyes of the user, and computing the adjusted capture direction based at least in part on the intersection point.

In some embodiments, the systems, methods, and apparatuses provided herein may be further configured to generate for display at the head-mounted computing device a graphical indicator that indicates a portion of the environment at which the detected gaze angle of the user is associated with in the captured second video, wherein the portion of the environment corresponds to the target location, and, in response to determining that the zoom of the camera has reached a digital zoom beyond an optical zoom limit, to modify the display of the graphical indicator.

In some embodiments, modifying the zoom of the camera is based on detecting a change in the gaze angle of the user or based on detecting that the gaze angle indicates that a gaze of the user has been directed at a particular portion of the environment for at least a threshold period of time.

In some embodiments, at least one of the first video the second video may be caused to be captured in response to detecting a particular blink pattern of an eye of the user.

In some embodiments, the systems, methods, and apparatuses provided herein may be further configured to determine that the first video depicts a particular type of subject matter, and perform each of adjusting the capture direction and adjusting the zoom of the camera based at least in part on determining that the first video depicts the particular type of subject matter.

### BRIEF DESCRIPTION OF THE DRAWINGS

The present disclosure, in accordance with one or more various embodiments, is described in detail with reference to the following figures. The drawings are provided for the purposes of illustration only and merely depict typical or example embodiments. These drawings are provided to facilitate an understanding of the concepts disclosed herein and should not be considered limiting of the breadth, scope, or applicability of these concepts. It should be noted that, for clarity and ease of illustration, these drawings are not necessarily made to scale.

FIG. 1A depicts an illustrative block diagram and process for adjusting a zoom and a capture direction of a camera based on a detected gaze angle, in accordance with some embodiments of this disclosure.

FIG. 1B depicts an illustrative block diagram and process for adjusting a zoom and a capture direction of a camera based on a detected gaze angle, in accordance with some embodiments of this disclosure.

FIG. 2 shows an illustrative device for adjusting a zoom and a capture direction of a camera based on a detected gaze angle, in accordance with some embodiments of this disclosure.

FIG. 3 shows an illustrative machine learning model, in accordance with some embodiments of this disclosure.

FIG. 4 shows an illustrative device for adjusting a zoom and a capture direction of a camera based on a detected gaze angle, in accordance with some embodiments of this disclosure.

FIG. 5 shows an illustrative computing device for adjusting a zoom and a capture direction of a camera based on a detected gaze angle, in accordance with some embodiments of this disclosure.

FIG. 6 depicts an illustrative block diagram and process for adjusting a rate of change of a capture direction based on a projected location of a tracked object, in accordance with some embodiments of this disclosure.

FIG. 7 is a flowchart of a detailed illustrative process for adjusting a zoom and a capture direction of a camera based on a detected gaze angle, in accordance with some embodiments of this disclosure.

FIGS. 8-9 depict illustrative devices, systems, servers, and related hardware for adjusting a zoom and a capture direction of a camera based on a detected gaze angle, in accordance with some embodiments of this disclosure.

FIG. 10 is a flowchart of a detailed illustrative process for adjusting a zoom and a capture direction of a camera based on a detected gaze angle, in accordance with some embodiments of this disclosure.

FIG. 11 is a flowchart of a detailed illustrative process for adjusting a rate of change of a capture direction based on a projected location of a tracked object, in accordance with some embodiments of this disclosure.

### DETAILED DESCRIPTION

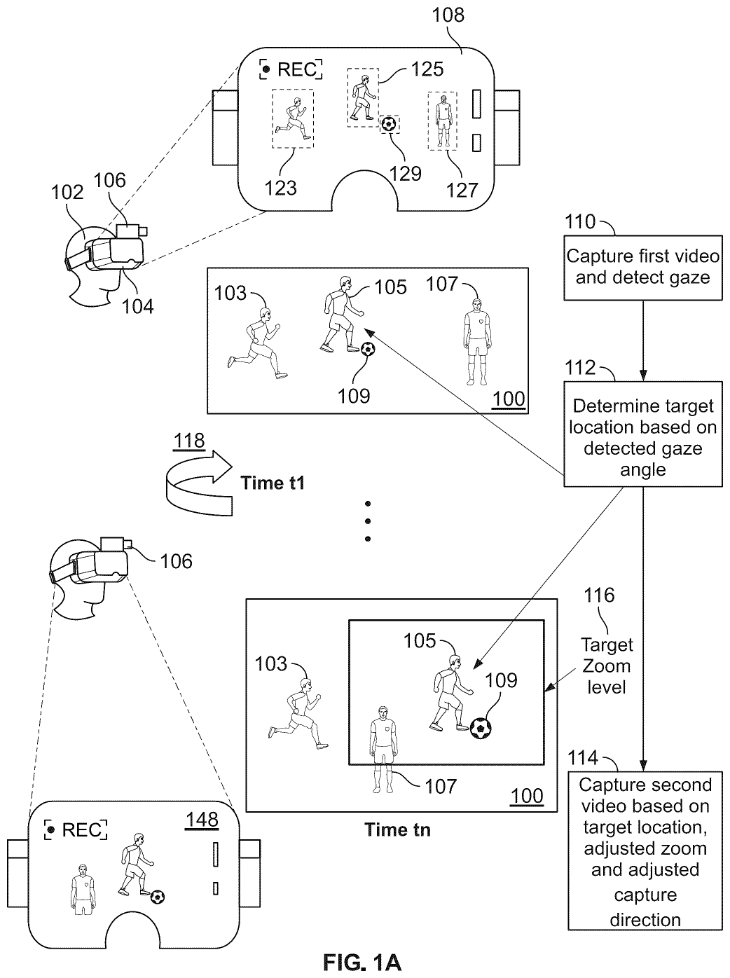

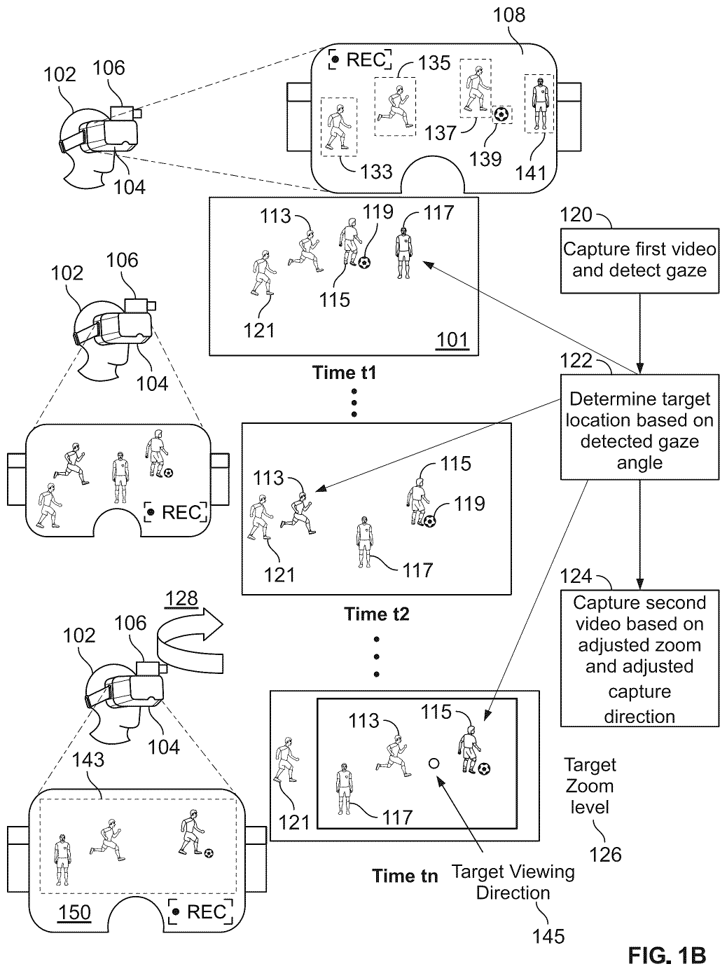

FIG. 1A depicts an illustrative block diagram and process for adjusting a zoom and a capture direction of a camera based on a detected gaze angle, in accordance with some embodiments of this disclosure. As shown in FIG. 1A, user 102 may be present at environment 100. Computing device 104 and/or camera 106 may be usable by user 102 to capture video of an event (e.g., a soccer game or any other suitable event) occurring in environment 100. Computing device 104 comprise or correspond to a head-mounted computing device; a mobile device such as, for example, a smartphone or a tablet; a camera; a camera array; a laptop computer; a tablet; a smart watch or wearable device; smart glasses; a stereoscopic display; a wearable camera; extended reality (XR) glasses; XR goggles; an XR head-mounted display (HMD); a near-eye display device; a robot; a drone; an unmanned aerial vehicle (UAV); any other suitable computing device; or any combination thereof. In some embodiments, environment 100 may be proximate to user 102 wearing computing device 104 and/or camera 106, or environment 100 may be remote from user 102, e.g., if camera 106 is mounted in a robot or UAV.

XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such an environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects. In some embodiments, environment 100 may be a real-world environment, an AR environment (e.g., a real-world environment depicted as having virtual objects overlaid thereon), or a VR environment.

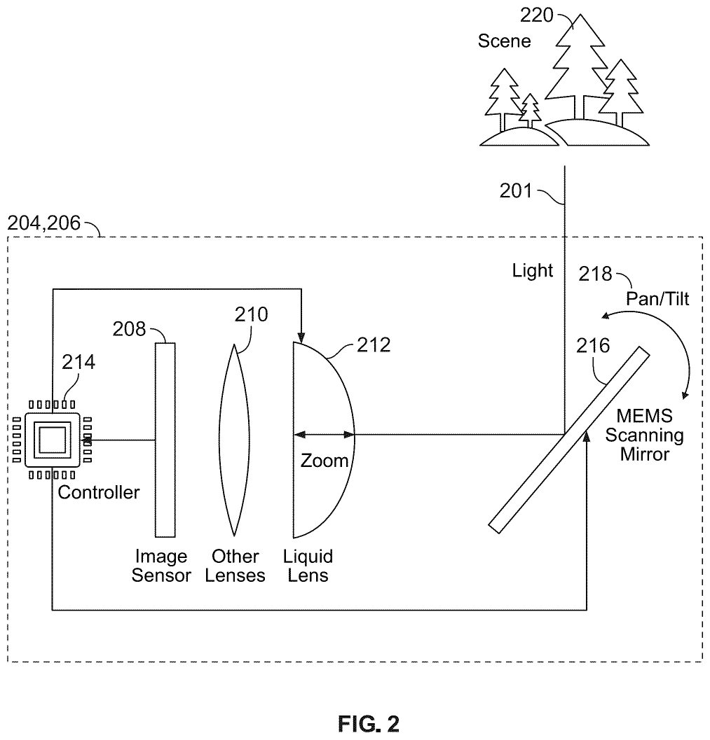

Computing device 102 may comprise, be attached to, be incorporated in, and/or otherwise be in communication with camera 106. Camera 106 may comprise one or more image sensors, e.g., a charge-coupled device (CCD); a complementary metal-oxide semiconductor (CMOS); or any other suitable sensor (e.g., optical sensors); or any suitable combination thereof. In some embodiments, camera 106 may comprise a camera direction control element (e.g., including microelectromechanical systems (MEMS) scanning mirror 216 of FIG. 2) for controlling a capture direction of the camera, and a camera zoom control element (e.g., including liquid lens 212 of FIG. 2) for controlling zoom of the camera. Camera 106 may be an outward-facing camera configured to capture images and/or video of environment 100 proximate to computing device 102. In some embodiments, camera 106 may correspond to a pan, tilt, and zoom (PTZ) camera. In some embodiments, camera 106 may be mounted in or on a robot or UAV.

In some embodiments, a video capture application may be executed at least in part on computing device 104 and/or camera 106 and/or at one or more remote servers and/or at or distributed across any of one or more other suitable computing devices, in communication over any suitable number and/or types of networks (e.g., the Internet). The video capture application may be configured to perform the functionalities (or any suitable portion of the functionalities) described herein. In some embodiments, the video capture application may be a stand-alone application, or may be incorporated as part of any suitable application, e.g., XR applications, video or image or electronic communication applications, social networking applications, image or video capturing and/or editing applications, image analysis applications, or any other suitable application(s), or any combination thereof.

In some embodiments, the video capture application may be understood as middleware or application software or any combination thereof. In some embodiments, the video capture application may be considered as part of an operating system (OS) of computing device 104 and/or as part of an OS of camera 106, or separate from the OS of computing device 104 and camera 106. The OS may be operable to initialize and control various software and/or hardware components of computing device 104. The video capture application may correspond to or be included as part of a video capture system, which may be configured to perform the functionalities described herein.

In some embodiments, the video capture application may be installed at or otherwise provided to a particular computing device, may be provided via an application programming interface (API), or may be provided as an add-on application to another platform or application. In some embodiments, software tools (e.g., one or more software development kits, or SDKs) may be provided to any suitable party, to enable the party to implement the functionalities described herein.

The video capture application may receive input to begin capturing a video of environment 100. Input may be received in any suitable form, e.g., as voice input, tactile input, input received via a keyboard or remote, input received via a touchscreen, text-based input, biometric input, or any other suitable input, or any combination thereof. As shown in FIG. 1A, display 108 of computing device 102 (or a display of camera 106) may depict the video of environment 100 that is currently being captured at 110. In some embodiments, such as when computing device 104 is a head-mounted computing device, display 108 of computing device 104 may be a passthrough display to present environment 100 to user 102. In some embodiments, a field of view (FOV) of a portion of environment 100 at a given time is presented to user 102 via display 108.

In some embodiments, the content displayed at display 108 may correspond to a preview of a video capable of being captured and stored by computing device 102 and/or camera 106, such as if suitable input is received from user 102 instructing an image to be captured. In some embodiments, such content may be continuously updated in real time as objects, persons, users and/or entities in environment 100 change locations or change their appearance or otherwise change. For example, computing device 104 may update the display of environment 100 captured by camera 106 as the objects or users move about the environment and/or as the field of view of computing device 104 changes. As referred to herein, the term “object” should be understood to refer to any person; character; avatar; structure; landmark; landscape; terrain; animal; item; thing; location; place; or any portion or component thereof; any suitable portion of the natural world or an environment; or any other suitable observable entity or attribute thereof visually depicted in an image or video.

In some embodiments, the video capture application may activate camera 106, and/or provide display 108, based on receiving input from user 102, e.g., selection of a particular button or option and/or a request to access a camera of computing device 104; based on voice input received at a microphone of computing device 104 and/or camera 106; based on detecting that computing device 104 and/or camera 106 is oriented in a desired direction; based on detecting that image sensor 208 is capturing visual content; and/or based on any other suitable input or criteria. In some embodiments, user 102 may be holding computing device 104 and/or camera 106, or user 102 may be wearing computing device 104, or user 102 may have mounted camera 106 on a tripod or other object. In some embodiments, image sensor 208 may be configured to automatically track one or more entities or objects in environment 100 captured by camera 106.

In some embodiments, the video being captured at 110 may be captured using certain parameters. For example, the capture of the first video at 110 may be initialized to a predefined or default optical or digital zoom setting (e.g., 1× representing a field of view as seen by the human eye without any zoom, or any other suitable value, or a particular focal length, such as, for example, 35 mm, or any other suitable value, or a particular zoom setting specified by the user) of camera 106. The first video being captured at 110 may be captured using a particular capture direction or viewing angle, e.g., the capture of the first video at 110 may be initialized to a detected gaze direction or gaze angle of user 102 in relation to display 108 of computing device 104 and/or in relation to environment 100. The gaze angle of user 102 may be used to identify a particular portion of display 108 (and/or environment 100) that a line of sight of user 102 is focused on. In some embodiments, adjusting the zoom and/or capture angle comprises switching to a different camera or different lens of computing device 104 and/or camera 106 to capture the video.

In some embodiments, to determine the gaze angle of user 102, one or more sensors of computing device 104 may be used to track one or both eyes of a user, to determine a portion of display 108 (e.g., within a field of view of the user) at which the user's gaze is directed or is focused, and the one or more sensors may transmit such sensor data to the video capture application. For example, an inward-facing or front-facing camera (e.g., disposed adjacent to or under display 108) of computing device 104 may be used to capture any suitable number of images or video of a user's eyes, and such images may be analyzed to track movement of a user's pupil and/or eyelids and/or movement of other portions of a user's eye, to track the eyes of the user, and/or any other suitable technique may be used to track the user's eye (e.g., glint in the user's eyes). In some embodiments, computing device 102 and/or camera 106 may comprise a light source (e.g., a light emitting diode (LED)) configured to illuminate one or both eyes of user 102 with light, and such light may be reflected off a portion(s) (e.g., a retina or cornea) of one or both eyes of user 102 to track different positions of the eye over time, with reference to boundaries of a frame (and/or boundaries of a display) represented by a coordinate system (e.g., X and Y coordinates, or Z coordinates in a three-dimensional system) to determine coordinates on display 108 corresponding to a gaze angle of user 102. The video capture application may use other reference points, such as coordinates of a field of play of a sporting match, or of any other bounded area, or granular coordinates may be used, e.g., quadrants of a bounded area. In some embodiments, computing device 102 may prompt a user to calibrate the gaze tracking system, prior to determining which portion of display 108 that user 102 is looking at.

In some embodiments, computer-implemented techniques (e.g., machine learning or heuristic-based image recognition) may be used in combination with the sensor data of the user's eyes to determine the user's gaze angle. In some embodiments, the video capture application may determine whether a user has gazed at a portion of the display 108 or environment for at least a threshold period of time, as measured by a timer. In some embodiments, the video capture application may determine a rate of change of the user's eyes, and track the movement of the user's eyes gazing at different locations.

In some embodiments, the video capture application employs any suitable computer-implemented technique to identify and track objects in environment 100. For example, the video capture application may employ machine learning and/or heuristic techniques in real time to identify and track athletes 103, 105, and 107 participating in a soccer game at environment 100, as well as to identify and track soccer ball 109 in environment 100. The video capturing application system may perform image segmentation (e.g., semantic segmentation and/or instance segmentation) to identify, localize, distinguish, and/or extract the different objects, and/or different types or classes of the objects, or portions thereof, in frames of the captured video. For example, such segmentation techniques may include determining which pixels in the captured video belong to athletes 103, 105, or 107 or soccer ball 109.

In some embodiments, segmentation may be performed using, for example: an image thresholding technique; an image segmentation technique; a computer vision technique; an image processing technique; object recognition; pattern recognition; an edge detection technique; a color pattern recognition technique; a partial linear filtering technique; regression algorithms; and/or neural network pattern recognition; or any other suitable technique; or any combination thereof. In some embodiments, the image processing system may utilize one or more machine learning models (e.g., naive Bayes algorithm, logistic regression, recurrent neural network, convolutional neural network (CNN), bi-directional long short-term memory recurrent neural network model (LSTM-RNN), or any other suitable model, or any combination thereof) to localize and/or classify objects in a given image or frame of the captured video.

In some embodiments, the video capture application may generate respective graphical indicators, e.g., bounding shapes, boxes or other bounding mechanisms surrounding a perimeter of and enclosing identified objects 103, 105, 107, and 109; only the four corners of a bounding box or any other suitable portion thereof; a highlighted shape to accentuate or emphasize a target location and/or zoomed in location; color changes; or any other suitable indication; or any combination thereof. The bounding shape may be any suitable shape (e.g., a circle, a box, a square, a rectangle, a polygon, an ellipse, or any other suitable shape, or any combination thereof). The bounding shape may be calculated in any suitable manner, and may be fitted to particular objects and/or portions of an image using any suitable technique, and other portions of the image may be excluded from the bounding shape. In some embodiments, as shown at display 108, the depictions of objects 103, 105, 107, and 109 may be surrounded by bounding boxes 123, 125, 127, and 129, respectively. Such bounding boxes may or may not be present in the captured video once such video is completed and subsequently stored or transmitted.

At 112, the video capture application may determine a target location (e.g., a location of a target object) based on the detected gaze of user 102. For example, the video capture application may determine the target location based on coordinates of an object 103, 105, 107, or 109, determined based on segmenting the frame, in environment 100 (and/or in the captured video displayed at display 108) that is closest to the coordinates associated with the detected gaze angle of user 102. In some embodiments, the target location may correspond to a particular portion of environment 100 and/or a particular portion of the captured video depicting environment 100 (e.g., a lower left portion, the portion of environment 100 bounded by the box associated with target zoom level 116, or any other suitable portion of any other suitable size, or any combination thereof). For example, the target location may comprise coordinates associated with the detected gaze angle of user 102 as well as a predefined (or dynamic) portion or range within environment 100 surrounding such coordinates. In some embodiments, the target location may be determined based on a history of detected gaze angles of user 102 and the corresponding captured scenes. The video capture application may determine the target location based on analysis of any suitable number of frames, e.g., a frame corresponding to time t1, a frame corresponding to time t2, and so on, or at any suitable time increment between frames. In some embodiments, the video capture application may prompt user 102 to confirm which object he or she is interested in including in the captured video, e.g., via an icon on a user interface of computing device 102, or based on receiving voice input “Track the location of player with the ball” or “Track my son, number 12.” In the example of FIG. 1A, the video capture application may determine that the target location corresponds to a location of object 105, e.g., based on a gaze of user 102 being determined to be directed at object 105 for at least a threshold period of time (e.g., 3 seconds) over (e.g., consecutively or non-consecutively) a particular time period (e.g., 5 seconds) of the captured video.

At 114, the video capture application may, based on the detected gaze angle of user 102 and the determined target location (e.g., target object 105), capture a second video using adjusted parameters, e.g., an adjusted zoom and an adjusted capture direction. Such second video may be part of the first video indicated at 110 captured with the adjusted parameters, or may be a new video captured with the adjusted parameters. The adjusted zoom may correspond to a target zoom level 116, which may be selected to capture the entirety of, or any suitable portion of, the target location, in this case object 105, as well as any other pertinent portions of the video, e.g., soccer ball 109, or a nearby defender 107, and to enlarge the size of such target object 105 and associated objects in the captured video. For example, the video capture application may identify which pixels in the captured video correspond to target object 105 and the associated objects (e.g., soccer ball 109), and cause camera 106 to zoom in on the portion of the captured video corresponding to such identified pixels. Such zooming may be optical zoom (using lens 210 and/or liquid lens 212 to magnify the desired portion of a frame of the video being captured) or digital zoom (using software to crop and enlarge the desired portion of a frame of the video being captured). In some embodiments, the zoom level may be limited by the resolution of the video, e.g., the video capture application may take into account the resolution of the video being captured in determining an appropriate adjusted zoom level. In some embodiments, zoom level 116 may be set based on coordinates associated with the detected gaze angle of user 102 as well as a predefined (or dynamic) portion or range within environment 100 surrounding such coordinates, to include such portions of environment 100 in the captured video.

In certain scenarios, adjusting the zoom level may correspond to zooming in or zooming out in relation to the previous zoom setting. Zooming in causes a more detailed view of the environment to be captured in the video, where a smaller portion of the environment is captured in the zoomed-in video. Zooming out causes a less detailed view of the environment to be captured in the video, where a larger portion of the environment is captured in the zoomed-out video. For example, if the target location is a particular object that is not interacting with other objects, it may be desirable to adjust the camera to zoom in on the target location in the video. On the other hand, if the target location is a particular object that is interacting with other objects, it may be desirable to zoom out to include each relevant object in the video. As another example, if an object is moving away from the camera, it may be desirable to adjust the video capture by zooming in to capture more detail of the target object, or to adjust the video capture by zooming out to capture a larger portion of the environment surrounding the target object. In some embodiments, if an object is moving towards the camera, it may be desirable to adjust the video capture by zooming out to capture a larger portion of the environment surrounding the target object, or to zoom in on the target object to exclude other portions of the environment which may not be related to the portion or object of interest.

As shown at 118 (and 218 of FIG. 2), the video capture application may be configured to adjust the capture direction of camera 106 based on the detected gaze and the target location by computing a desired pan (horizontal) angle and a desired tilt (vertical) angle of a capture direction control element of camera 106 to adequately capture the target location, e.g., at the coordinates of graphical indicators 125 and/or 129 associated with athlete 105 and soccer ball 109, respectively. The video capture application may determine the current pan angle and tilt angle and compare the current pan angle of camera 106 to the computed desired pan angle, as well as compare the current tilt angle of camera 106 to the computed desired tilt angle, to determine how the orientation of camera 106 is to be adjusted in relation to environment 100 to adequately capture the target location in the second video, which is depicted at interface 148 of FIG. 1A. Such features may enable adjusting the capture direction of the camera using a camera direction control element without receiving a direct or explicit user request to modify the camera direction, and adjusting the zoom of the camera using the camera zoom control element without receiving a direct or explicit user request to modify the zoom of the camera, to capture an optimal video of environment 100 for user 102. For example, in some embodiments, an initial input to execute an automatic object tracking and capture mode may be received may be received, but an explicity request to adjust zoom and/or modify capture direction may not be received.

FIG. 1B depicts an illustrative block diagram and process for adjusting a zoom and a capture direction of a camera based on a detected gaze angle, in accordance with some embodiments of this disclosure. The video capture application may receive input to begin capturing a video of environment 101. Input may be received in any suitable form, e.g., as voice input, tactile input, input received via a keyboard or remote, input received via a touchscreen, text-based input, biometric input, or any other suitable input, or any combination thereof. As shown in FIG. 1B, display 108 of computing device 102 (or a display of camera 106) may depict the video of environment 101 that is currently being captured at 120, which may include objects 113, 115, 117, 119, and 121, e.g., athletes participating in a soccer game and a soccer ball in environment 101.

At 122, the video capture application may determine the gaze angle of user 102 using the techniques described in connection with FIG. 1A. For example, the video capture application may determine the gaze angle of the user at time t1 of FIG. 1B indicates that a gaze of user 102 is directed at object 117. At subsequent time t2, the video capture application may determine that the detected gaze angle indicates that the gaze of the user has shifted to object 113. Since it may be ambiguous which of objects 117 or 113 the user is more interested in based on the gaze angle analysis performed at time t1 and time t2 of FIG. 1B indicating the user's gaze angle being directed at multiple different objects, to determine a target location in environment 101, the video capture application may perform processing to compute a weighted center point in environment 101 based on the gaze of user 102 over frames of the captured first video. In some embodiments, the center point may be computed by averaging the set of coordinates of each of the previously determined target locations in the relevant captured frames, e.g., the target location may be selected as a location in environment 101 that is between current or past coordinates of object 113 and object 117 (which may be static or dynamically changing). In some embodiments, pixel locations of a target location in more recently captured frames of the first video (e.g., the frame corresponding to time t2) may be assigned a higher weight than pixel locations of a target location in other less recently captured frames (e.g., the frame corresponding to time t1) in determining the target location. For example, the determined center point between object 113 and 117 may be shifted closer to object 113 than object 117 based on multiplying the determined center point by a weight associated with the frame corresponding to time t2.

In some embodiments, in determining the weighted center point, the video capture application may further take into account detecting that the gaze of the user has shifted to object 115 in the frame corresponding to time tn. For example, the video capture application may determine a center point between the coordinates of each of object 117 (the object of the user's gaze in the frame corresponding to time t1), object 113 (the object of the user's gaze in the frame corresponding to time t2), and object 115 (the object of the user's gaze in the frame corresponding to time tn), or any suitable combination thereof. In some embodiments, when determining the weighted center point, the portion of each frame corresponding to the target location may be assigned a higher weight in each successive frame than the previous frame, to weight the gaze angle of the user in more recent frames more heavily than portions of less recent frames corresponding to target locations. In some embodiments, target viewing direction 145 may be determined based on the determined weighted center point.

As shown at the lower portion of FIG. 1B, at time tn, the video capture application may determine target zoom level 126 and target viewing or capture direction 145, and may adjust the zoom and capture direction of computing device 104 and/or camera 106 based on such target zoom level 126 and target viewing or capture direction 145. In some embodiments, target zoom level 126 may be set based on bounding box 143, and the video capture application may cause bounding box 143 to comprise a portion of environment 100 that includes the points or coordinates associated with target viewing direction 145 and a portion of environment 100 of a predefined (or dynamic) size or range surrounding the coordinates associated with target zoom level 126. In some embodiments, target viewing direction 145 may correspond to a location, in environment 101 and displayed at display 108, corresponding to the computed weighted center. In some embodiments, target zoom level 126 may be selected such that each of objects 117, 113, and 115 (corresponding to the target locations in the frames captured at t1, t2, and tn, respectively) are included and clearly depicted in the second video captured at 124. In some embodiments, any objects (e.g., soccer ball 119) associated with the target location may be included in the portion of the captured second video focused on by target zoom level 126. Such second video may be part of the first video indicated at 120 captured with the adjusted parameters, or may be a new video captured with the adjusted parameters. The video capture application may cause the current zoom and capture direction settings of computing device 104 and/or camera 106 to correspond to target zoom level 126 and target viewing direction 145, respectively, in a similar manner as described in connection with FIG. 1A. Such features may enable adjusting the capture direction of the camera using a camera direction control element without receiving a direct or explicit user request to modify the camera direction, and adjusting the zoom of the camera using the camera zoom control element without receiving a direct or explicit user request to modify the zoom of the camera, to capture an optimal video of environment 101 for user 102.

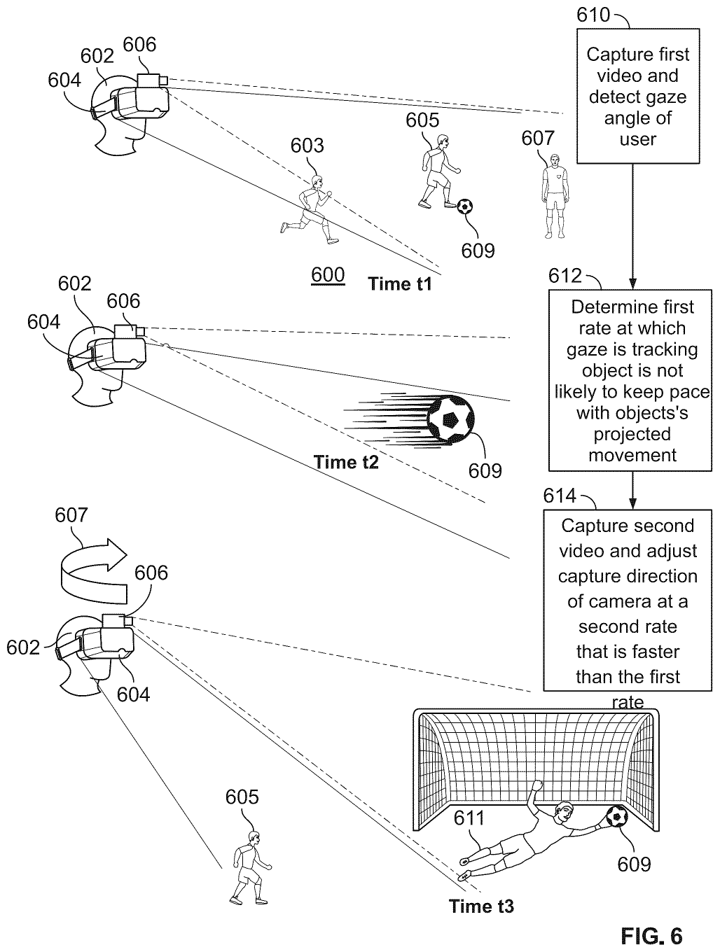

FIG. 2 shows an illustrative device for adjusting a zoom and a capture direction of a camera based on a detected gaze angle, in accordance with some embodiments of this disclosure. Computing device 204 and/or camera 206 may comprise image sensor 208 (e.g., a CMOS sensor or a CCD sensor), one or more lenses 210, liquid lens 212, controller 214, and MEMS scanning mirror 216, and/or any other suitable component(s), and/or any combination thereof. Computing device 204 and camera 206 may correspond to computing device 104 and camera 106 of FIGS. 1A-1B, respectively. Computing device 204 may comprise, be attached to, be incorporated in, and/or otherwise be in communication with camera 206. Controller 214 may comprise a hardware processor, a software processor (e.g., a processor emulated using a virtual machine), or any combination thereof, and may correspond to a central processing unit (CPU), microprocessor, microcontroller, or any suitable combination thereof. Computing device 204 and/or camera 206 may be configured to capture video of scene 220 (e.g., in environment 100 of FIG. 1A, or environment 101 of FIG. 1B, or environment 600 of FIG. 6).

Computing device 204 and/or camera 206 may be configured to receive light 201 from their surrounding environment based on light 201 reflecting off MEMS scanning mirror 216 towards liquid lens 212 and/or one or more other lenses 210. Liquid lens 212 and/or one or more other lenses 210 may be configured to focus the received light 201 towards image sensor 208. Image sensor 208 may detect received light 201 and generate image data based on the detected light by converting the detected light comprising photons into electrical signals. In some embodiments, computing device 204 and/or camera 206 may comprise multiple image sensors, e.g., at least one image sensor configured to receive light and generate images from scene 220, and at least one image sensor of an inward-facing camera configured to receive light and generate images of the user's eyes to detect a gaze angle of the user.

In some embodiments, the image data generated by image sensor 208 may be an analog output and digitized at an analog-to-digital converter for processing at controller 214. In some embodiments, controller 214 may execute the video capture application or may otherwise be instructed by the video capture application to cause capturing of video of scene 220, analyze or operate on pixels of the captured video and/or determine or received data regarding identified objects in the captured video, determine or receive data regarding detected gaze of the user (e.g., user 102 of FIG. 1A), control the various components of computing device 204 and/or camera 206, and determine (or otherwise be instructed by the video capture application) desired zoom and capture direction parameters to which the current parameters of the video capture are to be adjusted. In some embodiments, controller 214 may cause a captured video to be stored in memory and/or controller 214 may comprise input/output circuitry for causing a captured video to be transmitted to another computing device and/or to be transmitted via a communication network, and/or for computing device 204 to receive video data from camera 206.

In some embodiments, liquid lens 212 (and/or lens 210) may correspond to or be included in a camera zoom control element for controlling zoom of camera 206. Lens 210 may comprise any suitable number of lenses which may correspond to one or more of any suitable type of lens, e.g., ophthalmic lenses such as a concave lens or convex lens. In some embodiments, lens 210 may be a periscope lens, and may be front-facing or rear-facing.

Liquid lens 212 may be controllably used for zooming purposes, due to its compact size, rapid response time, and low power consumption. Liquid lens 212 may comprise an interface between two immiscible liquids with different refractive indices, and may be controlled to modify its focal length by altering the shape of such interface. For example, one of the liquids may be a conductive liquid (e.g., water or an aqueous solution) and the other liquid may be a non-conductive liquid (e.g., an oil). Controller 214 may be configured to control a lens shape of liquid lens 212 by applying an electrical voltage across the liquids, which modifies the surface tension between them. For example, when such electrical voltage is applied, the electro-wetting effect occurs, causing the surface tension of the conductive liquid to change, resulting in the modification of the liquid-liquid interface curvature, and as the curvature of the interface changes, so does the focal length of the lens.

In some embodiments, MEMS scanning mirror 216 may correspond to or be included in a camera direction control element for controlling a capture direction of the camera, to rapidly adjust viewing directions of camera 206, which may be outwardly facing scene 220 proximate to camera 206. MEMS scanning mirror 216 is a miniature device that uses microfabricated mechanical structures to control the reflection and direction of incoming light 201, and the mirror may rapidly oscillate or tilt in one or two axes (1D or 2D scanning) to steer a light beam across a surface or image sensor. For example, a pan and/or tilt angle 218 may be modified using an electrical signal from controller 214, based on the detected gaze angle of the user, to cause the capture angle of camera 206 to correspond to a portion of the environment at which the user is gazing at.

The combination of liquid lens 212 and MEMS scanning mirror 216 enables the video capture application to employ real-time control to rapidly respond to changing conditions and capture an optimal video of the environment surrounding the user. For example, as an object of interest of the user moves about scene 220 and the gaze angle of the user is determined to be tracking such object, the pan and/or tilt angle 218 may be adjusted based on a control signal from controller 214, which in turn adjusts the capture direction of camera 206, to enable the video being captured to include the user's object of interest. In addition, lens 210 and/or liquid lens 212 may be used to adjust the zoom to focus in on such object of interest, based on a control signal from controller 214. Controller 214 may control the image capturing and control liquid lens 212 to change its focal length so as to change the zoom level, and the panning and tilting of MEMS scanning mirror 216 allows camera 206 to capture a view of scene 220 at an adjusted capture angle, which may be based on a user's gaze and may be different than a direction the user is facing.

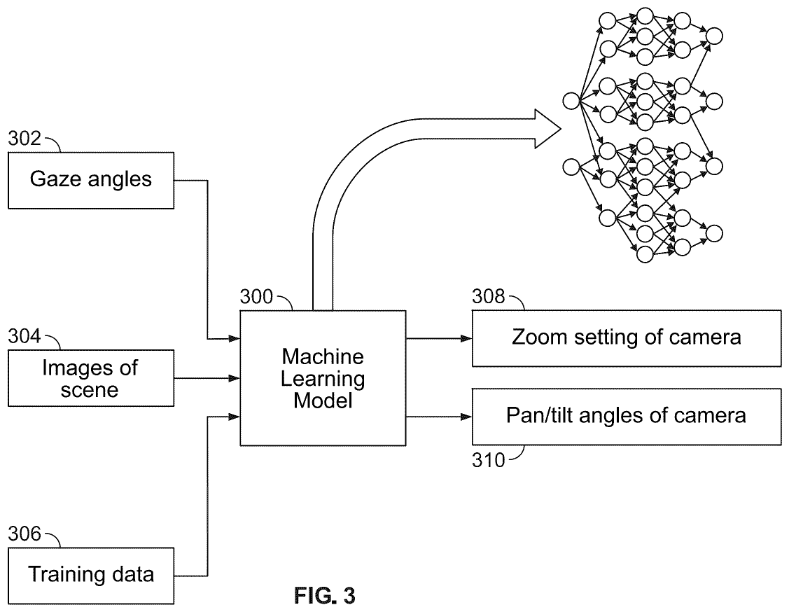

FIG. 3 shows an illustrative machine learning model 300, in accordance with some embodiments of this disclosure. In some embodiments, machine learning model 300 may be a neural network, e.g., a recurrent neural network, a transformer, a classifier, or any other suitable type of machine learning model, or any combination thereof. In some embodiments, machine learning model 300 may be trained to receive as input gaze angles 302 of a user over one or more frames of video of a particular scene and receive as input images of the particular scene 304 (e.g., scene 220 of FIG. 2), and output a zoom setting of a camera 308 and pan/tile capture angles of the camera 310 predicted to be desirable to capture an optimal video of a target location at which the user's gaze is determined to be detected, based on the received input. In some embodiments, machine learning model 300 may be trained using any suitable amount of training data 306, e.g., data pairs comprising a gaze angle sequence of a scene and imagery of the scene. In some embodiments, the output zoom setting 308 and the pan and/or tilt angle(s) of camera 310 may be used to adjust the parameters of a camera (e.g., camera 106 of FIG. 1A). In some embodiments, a type of the camera (e.g., camera 106) and associated capabilities may be input to model 300 and taken into account when generating outputs 308 and 310.

In some embodiments, machine learning model 300 may be trained by an iterative process of adjusting weights (and/or other parameters) for one or more layers of machine learning model 300. For example, the video capture application may compare the outputs obtained when training data 306 is input to model 300 to a ground truth value (e.g., an annotated indication of the correct input). The video capture application may then adjust weights or other parameters of machine learning model 300 based on how closely the output corresponds to the ground truth value. The training process may be repeated until results stop improving or until a certain performance level is achieved (e.g., until 95% accuracy is achieved, or any other suitable accuracy level or other metrics are achieved). In some embodiments, model 300 may be trained to learn features and patterns with respect to particular features of input images and gaze angle sequences and such learned patterns and inferences may be applied to received data once model 300 is trained. In some embodiments, model 300 may be trained or may continue to be trained on the fly or may be adjusted on the fly for continuous improvement, based on input data and inferences or patterns drawn from the input data, and/or based on comparisons after a particular number of cycles. In some embodiments, model 300 may be content-independent or content-dependent, e.g., may continuously improve with respect to certain types of content. In some embodiments, model 300 may comprise any suitable number of parameters.

In some embodiments, model 300 may be trained with any suitable amount of training data from any suitable number and/or types of sources. In some embodiments, machine learning model 300 may be trained by way of unsupervised learning, e.g., to recognize and learn patterns based on unlabeled data. In some embodiments, machine learning model 300 may be trained by supervised training with labeled training examples to help the model converge to an acceptable error range, e.g., to refine parameters, such as weights and/or bias values and/or other internal model logic, to minimize a loss function.

In some embodiments, each layer may comprise one or more nodes that may be associated with learned parameters (e.g., weights and/or biases), and/or connections between nodes may represent parameters learned during training (e.g., using backpropagation techniques, and/or any other suitable technique). In some embodiments, the nature of the connections may enable or inhibit certain nodes of the network. In some embodiments, the video capture application may be configured to receive (e.g., prior to training) user specification of (or automatic selection of) hyperparameters (e.g., a number of layers and/or nodes or neurons in each model). The video capture application may automatically set or receive manual selection of a learning rate, e.g., indicating how quickly parameters should be adjusted. In some embodiments, the training image data may be suitably formatted and/or labeled by human annotators or otherwise labeled via a computer-implemented process. As an example, such labels may be categorized as metadata attributes stored in conjunction with or appended to the training image data. Any suitable network training patch size and batch size may be employed for training model 300. In some embodiments, model 300 may be trained at least in part using a feedback loop, e.g., to help learn user preferences over time. In some embodiments, the video capture application may perform any suitable pre-processing steps with respect to training data, and/or data to be input to the trained machine learning model. Machine learning model 300, input data 302 and 304, and training data 306 may be stored at (and/or implemented at) any suitable device(s) and/or server(s) associated with the video capture application.

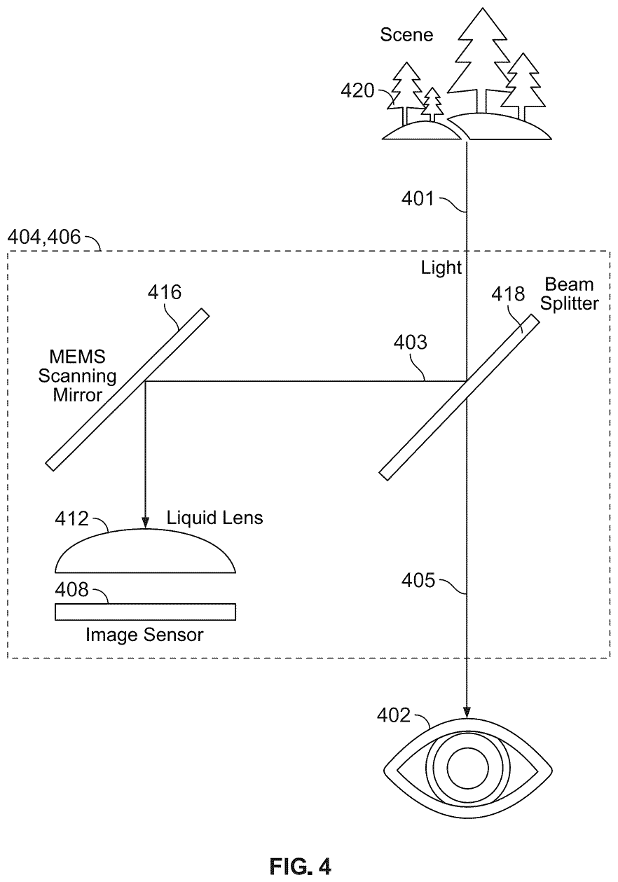

FIG. 4 shows an illustrative device for adjusting a zoom and a capture direction of a camera based on a detected gaze angle, in accordance with some embodiments of this disclosure. As shown in FIG. 4, computing device 404 and/or camera 406 may correspond to computing device 204 and/or camera 206 of FIG. 2, respectively; image sensor 408 may correspond to image sensor 208 of FIG. 2; liquid lens 412 may correspond to lens 212 of FIG. 2; MEMS scanning mirror 416 may correspond to MEMS scanning mirror 216 of FIG. 2. As shown in FIG. 4, computing device 404 and/or camera 406 may comprise any suitable optical component, such as, for example, beam splitter 418. Beam splitter 418 may be positioned in an optical path of incoming light 401 from scene 420 (e.g., from environment 100 of FIG. 1A or environment 101 of FIG. 1B). Beam splitter 418 may be configured to split light 201 into two separate light beams 403 and 405, where light beam 403 reflects off MEMS scanning mirror 416 to liquid lens 412 and image sensor 408, and light beam 405 may be directed towards one or both eyes of user 402. Beam splitter 418 may be used in such optical path to cause an optical center of camera 406 to correspond to a position as an eye of user 402, to enable the detected gaze angle to be quickly and accurately converted to the pan and tilt angle(s) of MEMS scanning mirror 416. Beam splitter 418 may be, for example, a cube beam splitter or a plate beam splitter, or any other suitable type of beam splitter, or any combination thereof. In some embodiments, beam splitter 418 may pass light to the eye and reflect the same to the camera.

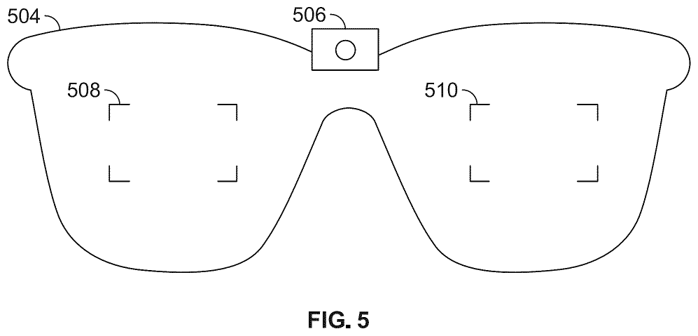

FIG. 5 shows an illustrative computing device for adjusting a zoom and a capture direction of a camera based on a detected gaze angle, in accordance with some embodiments of this disclosure. Computing device 504 (which may correspond to computing device 104 of FIG. 1A) may provide a display to the user of the environment that is external to computing device 504 and captured by camera 506 (which may correspond to camera 106 of FIG. 1A). In some embodiments, computing device 504 may be AR glasses. In some embodiments, the current capturing or viewing angle and zoom level of camera 506 may be indicated to the user via a display of computing device 504 or camera 506, e.g., to provide a feedback for the user, in the form of captured preview, or a graphical indicator to indicate to the user what region is being captured by the camera and what portion of the region is being gazed at by the user. As shown in FIG. 5, graphical indicator 508 and/or 510 may be displayed for one eye, for example, the dominant eye of the user, or to both eyes of the user. In some embodiments, the video capture application may modify the graphical indicator (e.g., by causing flickering of the graphical indicator or a color change of the graphical indicator or any other suitable modification or any combination thereof), e.g., to let the user know that the zoom level has reached a digital zoom beyond a limit of optical zoom (e.g., based on the focal length of a lens of camera 506). In some embodiments, the video capture application may detect a user response to such feedback, e.g., the user can intentionally move his or her eye gaze around or focus his or her eye gaze to change the zoom level.

In some embodiments, computing device 504 may comprise at least two cameras, e.g., an additional camera in addition to camera 506. For example, one of camera 506 or the additional camera may be used to capture the entire field of view of the environment (e.g., environment 100 of FIG. 1A) for analysis purposes and scene segmentation, and, based on such processing, the zoom level and capture direction of the other of camera 506 or the additional camera may be adjusted.

In some embodiments, since the optical systems of the two eyes of the user have different optical centers from camera 506, the video capture application may determine the desired capture direction to which the capture direction should be adjusted by determining the intersection of the two viewing directions of the eyes (e.g., based on images captured by an inwardly facing camera) and computing the direction from camera 506 to the intersection point and/or based on other photosensor(s) and/or projectors (e.g., infrared projectors). In some embodiments, the video capture application may perform auto focusing when the distance from the target location to the eyes is calculated. In some embodiments, the video capture application may employ additional controls to complement or override the automatic adjusting of the capture direction and the zoom of camera 506 based on detected gaze of the user. For example, any suitable input, e.g., eye gaze, blinking, a gesture, touch input, voice input, user interface input, remote control input, or any combination thereof, may be used by the user to instruct adjustment of the zoom level and/or capture direction of camera 506. In some embodiments, such input may be used to instruct computing device 504 and/or camera 506 to start or end video capture, or perform any other suitable function in relation to capturing video. In some embodiments, detecting user gaze at certain portions of the display of the computing device (e.g., top-left or bottom corners or any other suitable location or portion) may cause reset to reset a gaze angle and/or zoom level, to start recording, to end recording, or any other suitable command, or any combination thereof.

In some embodiments, the video capture application may perform scene analysis based on one or more previously captured frames. In some embodiments, camera 506 may be configured to capture video at a relatively high frame rate, such that for every two frames, one frame can be used for analysis purposes while the other may be captured for inclusion in the resulting video. In some embodiments, shutter speed may be modified for such every other frames. In some embodiments, the video capture application may set certain speed limits in relation to changing the zoom level and/or the capture angle (e.g., a rate at which such modification is permitted), where this limit may be predefined and/or modifiable by the user. In some embodiments, derived parameters, such as, for example, the zoom and gaze direction rate or changing speed, may be undergo processing, e.g., temporal filtering or Kalman filtering, to smooth out such parameters, e.g., filtering may be applied to captured frames to reduce and avoid abrupt changes in zooming. In some embodiments, the captured scene can be categorized into different categories (e.g., a sunset, a soccer game, track competitions, air shows, a wedding or any other suitable category) and a respective controlling scheme can be tailored to each category. In some embodiments, machine learning model 300 of FIG. 3 may be trained and/or provide outputs based at least in part on a particular determined category of a captured video.

FIG. 6 depicts an illustrative block diagram and process for adjusting a rate of change of a capture direction based on a tracked object, in accordance with some embodiments of this disclosure. As shown in FIG. 6, user 602 may be present at environment 600 that is proximate to computing device 604, and computing device 604 and/or camera 606 may be usable by user 602 to capture video of an event (e.g., a soccer game or any other suitable event) occurring in environment 600. Computing device 604 and camera 606 of FIG. 6 may correspond to computing device 104 and camera 106 of FIG. 1A.

The video capture application may receive input to begin capturing a video of environment 600. Input may be received in any suitable form, e.g., as voice input, tactile input, input received via a keyboard or remote, input received via a touchscreen, text-based input, biometric input, or any other suitable input, or any combination thereof. In some embodiments, a display (e.g., display 108 of FIG. 1A) of computing device 604 (or a display of camera 606) may depict the video of environment 600 that is currently being captured at 610. In addition, at 610, the video capture application may detect a gaze angle of user 602 at time t1 using the techniques described herein. For example, in the top portion of FIG. 6 showing environment 600 at time t1, the solid lines extending from computing device 604 represent a detected gaze angle of user 602 (e.g., directed at object 605 dribbling soccer ball 609), and the dotted lines represent a capture direction of camera 606 when capturing the first video. For example, initially the capture direction of camera 606 may be set to correspond to a gaze angle of user 602, and the zoom of camera 606 may correspond to a default value (e.g., 0.5×, 1×, 2× or any other suitable value). The video capture application may determine that the target location in at least the frames corresponding to times t1 and t2 comprises soccer ball 609. At 612, the video capture application may determine a first rate at which the gaze of user 602 is tracking the particular object of interest (e.g., soccer ball 609). In the frame corresponding to time t2, soccer ball 609 may be traveling at a relatively high speed, based on being kicked by athlete 605 towards goalie 611 shown at the lower portion of FIG. 6. The video capture application may determine, based on a current rate at which the gaze of user 602 has changed while tracking soccer ball 609 in previous frames and based on the speed of the soccer ball, that the gaze angle of user 602 is unlikely to be shifted in time to keep pace with soccer ball 609, and thus the capture direction of camera 606 (which may correspond to the gaze of user 602) may not be consistently capturing soccer ball 609 as user 602 desires.

For example, the video capture application may determine a projected path of the tracked object of interest (e.g., soccer ball 609) by comparing the location of soccer ball 609 in the frame at time t1 to the location of soccer ball 609 in the frame at time t2, to determine a vector representing the magnitude and direction of the motion of soccer ball 609. For example, as shown at time t3 in FIG. 6, the video capture application may (as shown at 607 and as represented by the dotted lines extending from camera 606 indicating the capture direction of camera 606) cause the capture direction of camera 606 to be adjusted based on projecting that a location of soccer ball 609 is likely to correspond to a location of goalie 611 and/or the goal that goalie 611 is defending. Thus, the goalie's saving of soccer ball 609 at time t3 may be included in the video captured by camera 606, even if a gaze of the user at time t3 (represented by the solid lines extending from computing device 604) is lagging behind the target location, e.g., due to the speed of a particular object corresponding to the target location. In some embodiments, determining a projected location of an object of interest may be performed at least in part based on the techniques disclosed in U.S. Pat. No. 11,076,200 issued Jul. 27, 2021, in the name of Rovi Guides, Inc., the contents of which is hereby incorporated by reference herein in its entirety.

In some embodiments, at 614, the video capture application may adjust the capture direction of camera 606 at a rate (e.g., rotation speed) that is faster than the rate (e.g., rotation speed) at which the detected gaze of user 602 has been shifted in the previous frames. In some embodiments, at 614, the video capture application, in capturing the video of goalie 611 saving soccer ball 609 at time t3, may adjust not only the capture direction of camera 606, but may also adjust the zoom setting of camera 606, to zoom in on (and capture enhanced detail of) goalie 611 saving soccer ball 609. In some embodiments, the zoom may be adjusted to include other relevant objects in the captured video, e.g., player 605 having kicked soccer ball 609 towards goalie 611 with the shot on goal.

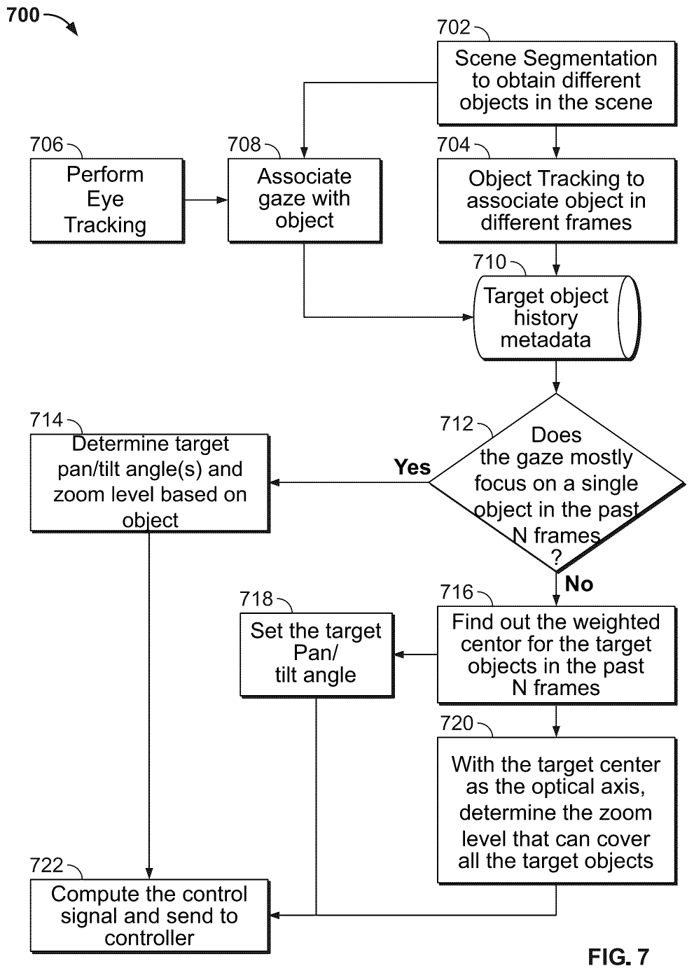

FIG. 7 is a flowchart of a detailed illustrative process 700 for adjusting a zoom and a capture direction of a camera based on a detected gaze angle, in accordance with some embodiments of this disclosure. In various embodiments, the individual steps of process 700 may be implemented by one or more components of the computing devices, processes, and systems of FIGS. 1-6 and 8-11 and may be performed in combination with any of the other processes and aspects described herein. Although the present disclosure may describe certain steps of process 700 (and of other processes described herein) as being implemented by certain components of the computing devices, processes and systems of FIGS. 1-6 and 8-11, this is for purposes of illustration only. It should be understood that other components of the computing devices, processes, and systems of FIGS. 1-6 and 8-11 may implement those steps instead.

At 702, the video capture application may perform scene segmentation to determine different objects in a scene being captured by a camera (e.g., camera 106 of FIG. 1A) associated with a computing device (e.g., computing device 104 of FIG. 1A). For example, the video capture application may identify objects 113, 115, 117, and 119 in environment 110 of FIG. 1B in a captured frame at time t1. The video capture application may use scene segmentation to segment the scene captured by camera 106 into various segments, each of which may or may not comprise different objects. At 704, the video capture application may perform object tracking to associate the object with respective locations in multiple different frames (e.g., captured video frames corresponding to time t1 and time t2, respectively, of FIG. 1B). For example, each object may be assigned coordinates in each frame indicating its location, in relation to a coordinate system associated with display 108 and/or environment 110 of FIG. 1B. In some embodiments, the scene segmentation and object tracking may comprise the video capture application generating graphical indicators (e.g., bounding boxes) 133, 135, 137, 139, and 141 (for objects 121, 113, 115, 119, and 117, respectively) at display 108 of FIG. 1B, which surround the perimeter of the objects and may be configured to be displayed and updated so as to move with the objects over time.

At 706, the video capture application may perform eye tracking to detect a user's gaze, to determine respective locations and/or objects in one or more frames of the captured video or image that the user is paying attention to or otherwise focused on. In some embodiments, at 704, the video capture application may employ an object tracking algorithm based at least in part on the techniques described in Bewley et al., “Simple Online and Realtime Tracking,” 2016 IEEE International Conference on Image Processing (ICIP) 25-28 Sep. 2016; Wojke et al., “Simple online and realtime tracking with a deep association metric,” 2017 IEEE International Conference on Image Processing (ICIP), 17-20 Sep. 2017; Zhang et al., “FairMOT: On the Fairness of Detection and Re-Identification in Multiple Object Tracking,” International Journal of Computer Vision, volume 129, pages 3069-3087 (2021), the contents of each of which are hereby incorporated by reference herein in their entireties.

At 708, the video capture application may associate the gaze of the user (e.g., user 102 of FIGS. 1A-1B) with a target location, which may comprise a particular object (e.g., object 105 in FIG. 1A at time t1, or object 117 in FIG. 1B at time t1). In some embodiments, the video capture application may determine whether the camera FOV being captured and the user's gaze are well aligned, e.g., whether the eye gaze of the user is included in the camera's FOV. If so, the object or location that the user is gazing at may be readily determined. Otherwise, the video capture application may identify a position or geometry (e.g., a spatial arrangement or angular orientation) of the camera with respect to the environment proximate to the camera, and the video capture application may determine a depth of the scene from a single view or multiple views. Given the intrinsic and extrinsic parameters of the eyes and the cameras, the video capture application can infer the object and/or location in the captured scene that the user is paying attention to or otherwise focused on. In some embodiments, front-facing cameras and/or mirrors on the computing device may be used to obtain a scene depth from a user perspective of the environment, which may be used to control a remote camera (e.g., mounted on a robot or UAV). In some embodiments, depth information may be included in metadata, e.g., pixel wise or segmentation wise, and/or foreground and background portions of the captured frame may be determined.

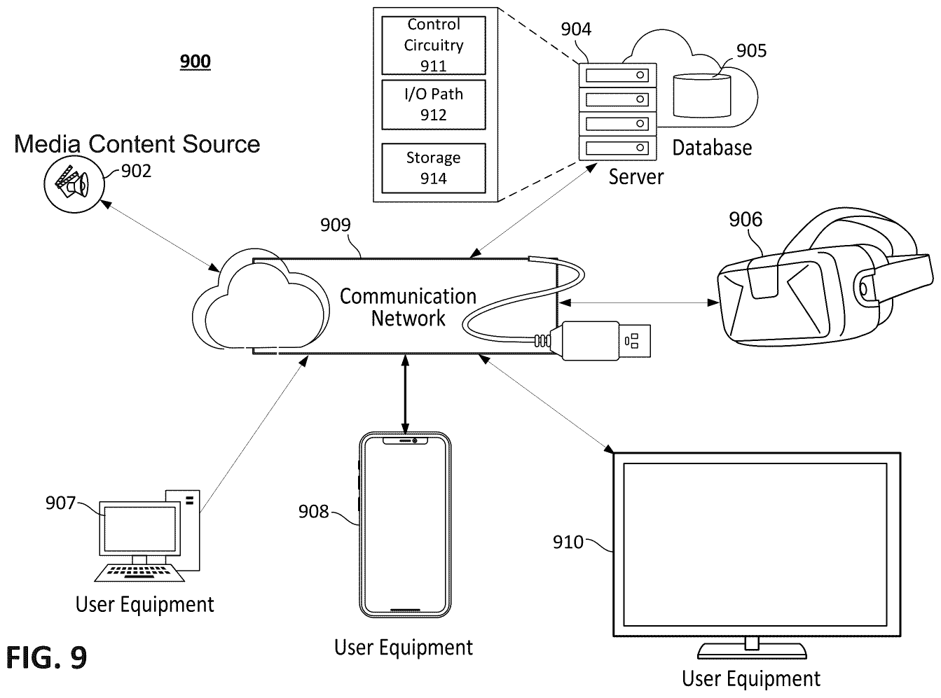

At 710, the video capture application may store the tracking results associated with each frame of the captured video and identified target locations and/or objects in a target object history database (e.g., server 904 or database 905 of FIG. 9), which may store metadata related to the tracking results. For example, such stored metadata may comprise the segmentation results from step 702 with different identifiers for each object or location in the captured frames, an identifier of a target object or target location in each frame, data distinguishing between foreground objects and background objects (to indicate that these two types of objects may be treated separately), any other suitable data, and/or any combination thereof. In some embodiments, a buffer may be used to temporarily hold frames and apply processing across multiple frames for consistency, and/or historical data may be stored in target history metadata indicated at 710.

At 712, the video capture application may determine whether the analysis of the previous N frames of the captured video at 702-710 indicates that the gaze of the user is primarily (e.g., over 50% of the captured frames), or exclusively, focused on a single object or a single target location. If so, processing may proceed to 714; otherwise processing may proceed to 716.

At 714, the video capture application may determine the target pan and/or tilt angle(s) and zoom level for the camera (e.g., camera 106 of FIGS. 1A-1B) based on the identified target object or target location. For example, the video capture application may obtain the bounding boxes for each of relevant captured frame(s), e.g., bounding boxes 123, 125, 127, and 129 (for objects 103, 105, 107, and 109, respectively, of FIG. 1A) and may determine a center of the graphical indicator (e.g., bounding box 125) for the target object (e.g., object 105). The video capture application may compute the desired pan and/or tilt angle of MEMS scanning mirror of the camera, to direct the capture angle of the camera at the determined center of the graphical indicator of object 105.

At 714, the video capture application may further determine, based on the determined center of such graphical indicator 125, a desired zoom level for the camera. In some embodiments, the desired zoom level may be selected such that the captured video or image includes a portion of the image of video having the relevant graphical indicator 125 with at least a certain margin or range outside the bounding boxes, e.g., at least ⅓ (or any other suitable value) of the width/height in each direction surrounding the bounding box, or a certain margin or range outside a target object or target coordinates determined based on the detected gaze of the user. In some embodiments, soccer ball 109 that object 105 is kicking may be considered as part of the object 105 and the capture direction and/or zoom level of the camera may be adjusted to include object 105 when soccer ball 109 is being kicked by the athlete corresponding to object 105 in the captured frames of the video, given the context of the object for the type of the captured video (e.g., the importance of a soccer ball in a soccer game). In some embodiments, a user profile of user 102 or a content profile for the particular type of scene being captured may be associated with various capture settings, e.g., presets for fast- and slow-motion scenes, or any other suitable preferences, or any combination thereof.

At 716, the video capture application may, having determined that the gaze is not primarily (e.g., over 50% of the captured frames), or exclusively, focused on a single object in the past N frames at different times (e.g., time t1, time t2, . . . of FIG. 1B), obtain the bounding boxes for each of the relevant captured frame(s), e.g., bounding boxes 133, 135, 137, 139, and 141 (for objects 121, 113, 115, 119, and 117, respectively of FIG. 1B). For example, the video capture application may determine that at the frame corresponding to time t1, the user's gaze angle is directed at object 117; at the frame corresponding to time t2, the user's gaze angle is directed at object 113; and/or at the frame corresponding to time tn, the user's gaze angle is directed at object 115. Based on such determinations, the video capture application may generate a combined graphical indicator 143 at interface 150 of FIG. 1B that includes each of object 113, 117 and/or 115, and may determine a center of such graphical indicator (or other suitable indicator). At 718, the video capture application may compute the desired pan and/or tilt angle of MEMS scanning mirror of the camera, to direct the capture angle of the camera at the determined center of graphical indicator 143 of FIG. 1B.

At 720, the video capture application may determine, based on the determined center of such graphical indicator 143, a desired zoom level for the camera. In some embodiments, the desired zoom level may be selected such that the captured video or image includes a portion of the image of video having the relevant graphical indicator 143 with at least a certain margin or range outside the bounding boxes, e.g., at least ⅓ (or any other suitable value) of the width/height in each direction surrounding the bounding box. In some embodiments, soccer ball 119 that object 115 is kicking may be considered as part of the object 115 and the capture direction and/or zoom level of the camera may be adjusted to include object 105 when soccer ball 119 is being kicked by the athlete corresponding to object 115 in the captured frames of the video, given the context of the object for the type of the captured video (e.g., the importance of a soccer ball in a soccer game). The zoom of the captured video may be selected such that each of such target objects are included in adequate detail in the captured frames.

In some embodiments, the target location in a more recent frame (e.g., the frame captured at time t2 of FIG. 1B) may be assigned a higher weight than the target location in a less recent frame (e.g., the frame captured at time t1 of FIG. 1B). For example, based on such higher assigned weight, the video capture application may consider the center of graphical indicator 143 to be offset towards target object 115 of the more recent frame, and/or adjust the zoom to focus primarily (e.g., over 50% of the captured frames), or exclusively, on object 115, while still including at least a portion of object 117, which was focused on at time t1, in the captured frame. This may enable the captured video to accord more weight to an object being associated with the most recent gaze angle of the user, while still including in the captured video objects included in the gaze of the user in less recent frames.

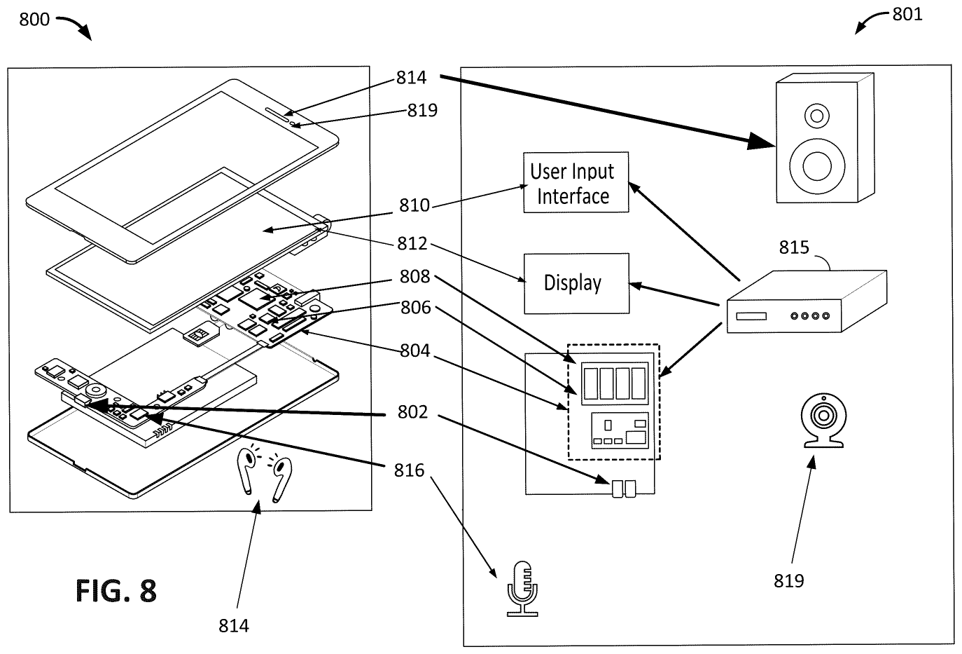

FIGS. 8-9 depict illustrative devices, systems, servers, and related hardware for adjusting a zoom and a capture direction of a camera based on a detected gaze angle, in accordance with some embodiments of this disclosure. FIG. 8 shows generalized embodiments of illustrative computing devices 800 and 801, which may correspond to, e.g., computing device 104 and/or camera 106 of FIGS. 1A-1B, and computing device 604 and/or camera 606 of FIG. 6. For example, computing device 800 may be: a camera; a smartphone device; a tablet; a near-eye display device; a VR or AR device; a head-mounted computing device; a mobile device; or any other suitable device capable of capturing video and/or processing captured video and/or adjusting captured settings; or any combination thereof. In another example, computing device 801 may be a user television equipment system or device. Computing device 801 may include set-top box 815. Set-top box 815 may be communicatively connected to microphone 816, audio output equipment (e.g., speaker or headphones 814), and display 812. In some embodiments, microphone 816 may receive audio corresponding to a voice of a video conference participant and/or ambient audio data during a video conference. In some embodiments, display 812 may be a television display or a computer display. In some embodiments, set-top box 815 may be communicatively connected to user input interface 810. In some embodiments, user input interface 810 may be a remote control device. Set-top box 815 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 9. In some embodiments, computing device 800 may comprise any suitable number of sensors (e.g., gyroscope or gyrometer, or accelerometer, etc.), and/or a GPS module (e.g., in communication with one or more servers and/or cell towers and/or satellites) to ascertain a location of computing device 800. In some embodiments, computing device 800 comprises a rechargeable battery that is configured to provide power to the components of the computing device.

Each one of computing device 800 and computing device 801 may receive content and data via input/output (I/O) path 802. I/O path 802 may provide content (e.g., broadcast programming, on-demand programming, Internet content, content available over a local area network (LAN) or wide area network (WAN), and/or other content) and data to control circuitry 804, which may comprise processing circuitry 806 and storage 808. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths, but are shown as a single path in FIG. 8 to avoid overcomplicating the drawing. While set-top box 815 is shown in FIG. 8 for illustration, any suitable computing device having processing circuitry, control circuitry, and storage may be used in accordance with the present disclosure. For example, set-top box 815 may be replaced by, or complemented by, a personal computer (e.g., a notebook, a laptop, a desktop), a smartphone (e.g., computing device 800), an AR or VR device, a tablet, a network-based server hosting a user-accessible client device, a non-user-owned device, any other suitable device, or any combination thereof. In some embodiments, controller 214 may correspond to control circuitry 804 of FIG. 8 and/or control circuitry 911 of FIG. 9.

Control circuitry 804 may be based on any suitable control circuitry such as processing circuitry 806. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for the video capture application stored in memory (e.g., storage 808). Specifically, control circuitry 804 may be instructed by the video capture application to perform the functions discussed above and below. In some implementations, processing or actions performed by control circuitry 804 may be based on instructions received from the video communication application.

In client/server-based embodiments, control circuitry 804 may include communications circuitry suitable for communicating with a server or other networks or servers. The video capture application may be a stand-alone application implemented on a computing device or a server. The video capture application may be implemented as software or a set of executable instructions. The instructions for performing any of the embodiments discussed herein of the video capture application may be encoded on non-transitory computer-readable media (e.g., a hard drive, random-access memory on a DRAM integrated circuit, read-only memory on a BLU-RAY disk, etc.). For example, in FIG. 8, the instructions may be stored in storage 808, and executed by control circuitry 804 of a computing device 800.

In some embodiments, the video capture application may be a client/server application where only the client application resides on computing device 800 (e.g., computing device 104 of FIG. 1A), and a server application resides on an external server (e.g., server 904 of FIG. 9). For example, the video capture application may be implemented partially as a client application on control circuitry 804 of computing device 800 and partially on server 904 as a server application running on control circuitry 911. Server 904 may be a part of a local area network with one or more of computing devices 800, 801 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 904 and/or an edge computing device), referred to as “the cloud.” Computing device 800 may be a cloud client that relies on the cloud computing capabilities from server 904 to determine how to adjust a capture direction and a zoom of a camera capturing a video, based on a detected gaze angle of a user in an environment that is proximate to the camera. When executed by control circuitry of server 904, the video capture application may instruct control circuitry 811 to perform such tasks. The client application may instruct control circuitry 804 to perform such tasks.

Control circuitry 804 may include communications circuitry suitable for communicating with a video communication or video conferencing server, content servers, social networking servers, video gaming servers, edge computing systems and devices, a table or database server, or other networks or servers. The instructions for carrying out the above mentioned functionality may be stored on a server (which is described in more detail in connection with FIG. 9). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 9). In addition, communications circuitry may include circuitry that enables peer-to-peer communication of computing devices, or communication of computing devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as video capture application data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 804 may also include scaler circuitry for upconverting and downconverting content into the preferred output format of computing device 800. Control circuitry 804 may also include digital-to-analog converter circuitry and analog-to-digital converter circuitry for converting between digital and analog signals. The tuning and encoding circuitry may be used by computing device 800, 801 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from computing device 800, the tuning and encoding circuitry (including multiple tuners) may be associated with storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of computing device 800 and computing device 801. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, or any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information to set-top box 815.

Audio output equipment 814 may be integrated with or combined with display 812. Display 812 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card or graphical processing unit (GPU) may generate the output to display 812. Audio output equipment 814 may be provided as integrated with other elements of each one of computing device 800 and computing device 801 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 816 or audio output equipment 814 may include a microphone configured to receive audio input such as voice commands or speech. For example, a user may speak letters or words that are received by the microphone and converted to text by control circuitry 804. In a further example, a user may voice commands that are received by a microphone and recognized by control circuitry 804. Camera 819 may be any suitable video camera integrated with the equipment or externally connected. Camera 819 may be a digital camera comprising a charge-coupled device (CCD) and/or a complementary metal-oxide semiconductor (CMOS) image sensor, which may correspond to image sensor 208 of FIG. 2. In some embodiments, camera 819 may be an analog camera that converts to digital images via a video card. In some embodiments, camera 819 may correspond to camera 206 of FIG. 2 and may comprise image sensor 208, lenses 210, liquid lens 212, controller 214, MEMS scanning mirror, and/or any other suitable optical components, or any combination thereof.

The video capture application may be implemented using any suitable architecture. For example, it may be a stand-alone application wholly implemented on each one of computing device 800 and computing device 801. In such an approach, instructions of the application may be stored locally (e.g., in storage 808), and data for use by the application is downloaded on a periodic basis (e.g., from an out-of-band feed, from an Internet resource, or using another suitable approach). Control circuitry 804 may retrieve instructions of the application from storage 808 and process the instructions to provide video conferencing functionality and generate any of the displays discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 804 may allow a user to provide user profile information or may automatically compile user profile information. For example, control circuitry 804 may access and monitor network data, video data, audio data, processing data, participation data from a conference participant profile. Control circuitry 804 may obtain all or part of other user profiles that are related to a particular user (e.g., via social media networks), and/or obtain information about the user from other sources that control circuitry 804 may access. As a result, a user can be provided with a unified experience across the user's different devices.

In some embodiments, the video capture application is a client/server-based application. Data for use by a thick or thin client implemented on each one of computing device 800 and computing device 801 may be retrieved on-demand by issuing requests to a server remote to each one of computing device 800 and computing device 801. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on computing device 800. This way, the processing of the instructions is performed remotely by the server while the resulting displays (e.g., that may include text, a keyboard, or other visuals) are provided locally on computing device 800. Computing device 800 may receive inputs from the user via input interface 810 and transmit those inputs to the remote server for processing and generating the corresponding displays. For example, computing device 800 may transmit a communication to the remote server indicating that an up/down button was selected via input interface 810. The remote server may process instructions in accordance with that input and generate a display of the application corresponding to the input (e.g., a display that moves a cursor up/down). The generated display may then be transmitted to computing device 800 for presentation to the user.

In some embodiments, the video capture application may be downloaded and interpreted or otherwise run by an interpreter or virtual machine (run by control circuitry 804). In some embodiments, the video capture application may be encoded in the ETV Binary Interchange Format (EBIF), received by control circuitry 804 as part of a suitable feed, and interpreted by a user agent running on control circuitry 804. For example, the video capture application may be an EBIF application. In some embodiments, the video capture application may be defined by a series of JAVA-based files that are received and run by a local virtual machine or other suitable middleware executed by control circuitry 804. In some of such embodiments (e.g., those employing MPEG-2, MPEG-4, HEVC or any other suitable digital media encoding schemes), video capture application may be, for example, encoded and transmitted in an MPEG-2 object carousel with the MPEG audio and video packets of a program.

As shown in FIG. 9, devices 906, 907, 908, and 910 may be coupled to communication network 909. In some embodiments, each of computing devices 906, 907, 908, and 910 may correspond to one of computing devices 800 or 801 of FIG. 8, computing device 104 and/or camera 106 of FIG. 1, or computing device 604 and/or camera 606 of FIG. 6. Computing device 906 is a head-mounted computing device, e.g., corresponding to computing device 104 and/or 604 and/or camera 106 and/or 606. Communication network 909 may be one or more networks including the Internet, a mobile phone network, mobile, voice or data network (e.g., a 5G, 4G, or LTE network), cable network, public switched telephone network, or other types of communication network or combinations of communication networks. Paths (e.g., depicted as arrows connecting the respective devices to the communication network 909) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 909.

System 900 may comprise media content source 902, one or more servers 904, and/or one or more edge computing devices. In some embodiments, the video capture application may be executed at one or more of control circuitry 911 of server 904 (and/or control circuitry of computing devices 906, 907, 908, 910 and/or control circuitry of one or more edge computing devices). In some embodiments, media content source 902 and/or server 904 may be configured to host or otherwise facilitate communication sessions between computing devices 906, 907, 908, 910 and/or any other suitable devices, and/or host or otherwise be in communication (e.g., over network 909) with one or more social network services.

In some embodiments, server 904 may include control circuitry 911 and storage 914 (e.g., RAM, ROM, Hard Disk, Removable Disk, etc.). Storage 914 may store one or more databases. Server 904 may also include an input/output path 912. I/O path 912 may provide video conferencing data, device information, or other data, over a local area network (LAN) or wide area network (WAN), and/or other content and data to control circuitry 911, which may include processing circuitry, and storage 914. Control circuitry 911 may be used to send and receive commands, requests, and other suitable data using I/O path 912, which may comprise I/O circuitry. I/O path 912 may connect control circuitry 911 (and specifically control circuitry) to one or more communications paths.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 911 executes instructions for an emulation system application stored in memory (e.g., the storage 914). Memory may be an electronic storage device provided as storage 914 that is part of control circuitry 911.

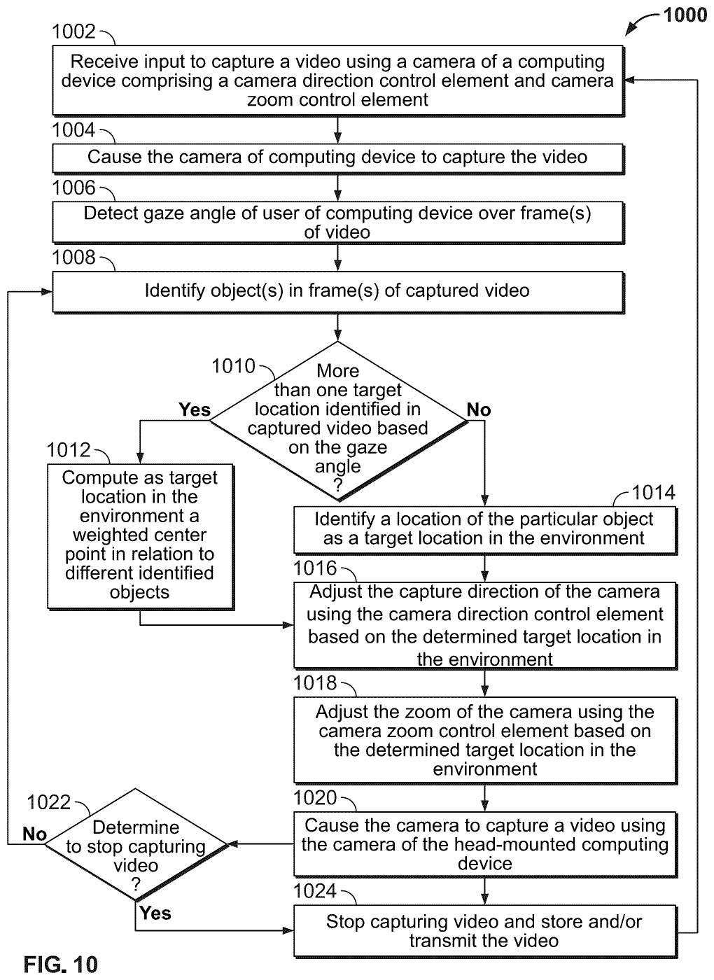

FIG. 10 is a flowchart of a detailed illustrative process 1000 for adjusting a zoom and a capture direction of a camera based on a detected gaze angle, in accordance with some embodiments of this disclosure. In various embodiments, the individual steps of process 1000 may be implemented by one or more components of the computing devices, processes, and systems of FIGS. 1-9 and 11 and may be performed in combination with any of the other processes and aspects described herein. Although the present disclosure may describe certain steps of process 1000 (and of other processes described herein) as being implemented by certain components of the computing devices, processes, and systems of FIGS. 1-9 and 11, this is for purposes of illustration only. It should be understood that other components of the computing devices, processes, and systems of FIGS. 1-9 and 11 may implement those steps instead. At 1002, I/O circuitry (e.g., I/O circuitry 802 of computing device 800 of FIG. 8 and/or

I/O circuitry 912 of server 904 of FIG. 9) may receive input to capture a video using a camera (e.g., camera 106 of FIG. 1A) of a computing device (e.g., computing device 104 of FIG. 1A). Such a camera may comprise a camera direction control element (e.g., MEMS scanning mirror 216 of FIG. 2) and camera zoom control element (e.g., liquid lens 212 of FIG. 2). Such input may be received in any suitable form, e.g., as voice input, tactile input, input received via a keyboard or remote, input received via a touchscreen, text-based input, biometric input, or any other suitable input, or any combination thereof. In some embodiments, the input received at 1002 may correspond to receiving selection of a video or imaging application provided by an operating system of (or an application installed on) the computing device and/or the camera interfacing with various components (e.g., image sensor 208, lenses 210, liquid lens 212, MEMS scanning mirror 216, controller 214, and/or any other suitable components).

At 1004, control circuitry (e.g., control circuitry 804 of computing device 800 of FIG. 8 and/or control circuitry 911 of server 904 of FIG. 9) may cause the camera (e.g., camera 106 of FIG. 1A) of the computing device (e.g., computing device 104 of FIG. 1A) to capture the video. In some embodiments, a zoom of the camera may be set to a predefined value upon starting to capture the video, and the capture direction may be set to align with a gaze angle of the user (e.g., once gaze detection is performed at 1006). In some embodiments, the captured video may be displayed at a display of the computing device (e.g., display 108 of computing device 104 of FIG. 1A) and/or a display of the camera (e.g., camera 106 of FIG. 1A). In some embodiments, the video being captured may be stored locally (e.g., in a buffer or in long-term storage), may be shown in a preview screen (e.g., with or without recording the video for long-term storage), may be broadcast as a live stream to other users, or any suitable combination thereof.

At 1006, the I/O circuitry and/or the control circuitry may detect a gaze angle of the user of computing device 104 and/or camera 106 over frame(s) of the captured video. For example, to determine the gaze angle of the user (e.g., user 102 of FIG. 1A), one or more sensors of the computing device (e.g., computing device 104 of FIG. 1A) and/or of the camera (e.g., camera 106 of FIG. 1A) may be used to track one or both eyes of a user, to determine a portion of display (e.g., display 108 of computing device 104 of FIG. 1A) and/or the environment (e.g., environment 100) at which the user's gaze is directed or is focused, and the one or more sensors may transmit such sensor data to the I/O circuitry and/or the control circuitry. For example, an inward-facing or front-facing camera (e.g., disposed adjacent to or under display 108 of FIG. 1A) of the computing device may be used to capture any suitable number of images or video of a user's eyes, and such images may be analyzed to track movement of a user's pupils and/or eyelids and/or movement of other portions of a user's eyes, to track the eyes of the user, and/or any other suitable technique may be used to track the user's eyes (e.g., glint in the user's eyes).

In some embodiments, the computing device and/or camera may comprise a light source (e.g., an LED) configured to illuminate one or both eyes of the user with light, and such light may be reflected off a portion(s) (e.g., a retina or cornea) of one or both eyes of the user to track different positions of the eye over time, with reference to boundaries of a frame (and/or boundaries of a display 108 of FIG. 1A) represented by a coordinate system (e.g., X and Y coordinates, Z coordinates in a three-dimensional system) to determine coordinates on display 108 corresponding to a gaze angle of user 102. In some embodiments, computer-implemented techniques (e.g., machine learning or heuristic-based image recognition) may be used in combination with the sensor data of the user's eyes to determine the user's gaze angle. In some embodiments, the video capture application may determine whether a user has gazed at a portion of the display (e.g., display 108 of FIG. 1A) or environment for at least a threshold period of time, as measured by a timer (e.g., included in computing device 104 of FIG. 1). In some embodiments, the video capture application may determine a rate of change of the user's eyes, and track the movement of the user's eyes gazing at different locations.

At 1008, the control circuitry may be configured to identify object(s) in frame(s) of the captured video using any suitable computer-implemented technique. For example, as shown in FIG. 1A, the video capture application may employ machine learning and/or heuristic techniques in real time to identify and track athletes 103, 105, and 107 participating in a soccer game at environment 100, as well as to identify and track soccer ball 109 in environment 100. The video capturing application system may perform image segmentation (e.g., semantic segmentation and/or instance segmentation) to identify, localize, distinguish, and/or extract the different objects, and/or different types or classes of the objects, or portions thereof, in frames of the captured video. For example, such segmentation techniques may include determining which pixels in the captured video belong to athletes 103, 105, or 107 or soccer ball 109.

In some embodiments, the video capture application may generate respective bounding shapes, boxes or other bounding mechanisms surrounding a perimeter of and enclosing identified objects 103, 105, 107, and 109. For example, as shown at display 108 of FIG. 1B, the depictions of objects 103, 105, 107, and 109 may be surrounded by bounding boxes 123, 125, 127, and 129, respectively. Such bounding boxes may or may not be present in the captured video once such video is completed and subsequently stored or transmitted.

At 1010, the control circuitry may determine whether more than one target location has been identified in the captured video based on the detected gaze angle. For example, the control circuitry may compare coordinates corresponding to the user's gaze (determined at 1006) in each captured frame to coordinates of objects or other portions of the video determined based on the segmentation performed at 1008. If, as in the example of FIG. 1A, the control circuitry determines that the gaze of the user primarily or only corresponds to a particular target location (e.g., object 105), processing may proceed to 1014. Otherwise, if as in the example of FIG. 1B the control circuitry determines that more than one object (e.g., object 117 in the frame corresponding to time t1 in FIG. 1B, object 113 in the frame corresponding to time t2 in FIG. 1B, and/or object 115 in the frame corresponding to time tn in FIG. 1B) corresponds to the gaze of the user over the plurality of frames, processing may proceed to 1012.

At 1012, the control circuitry may compute as a target location in the environment a weighted center point in relation to different identified objects (e.g., object 117 in the frame corresponding to time t1 in FIG. 1B, object 113 in the frame corresponding to time t2 in FIG. 1B, and/or object 115 in the frame corresponding to time tn in FIG. 1B). For example, the control circuitry, having determined that the user (e.g., user 102 of FIG. 1B) is not focused on a single target object, but instead, looking at different objects at different times of the captured video, may compute the object locations in the current camera frame, and project this location back to the direction in the world frame, and compute a weighted center in the world frame for the past target objects directions, while the weight can be set higher for recent frames. This weighted center may be set as the target viewing direction, and a control signal may be calculated based on this direction for the camera direction control element (e.g., to modify the pan and/or tilt angle(s) of MEMS scanning mirror 216 of FIG. 2). In some embodiments, after the viewing direction is set, a target zoom level may be calculated such that each of the objects having been gazed at by the user in the prior frames (e.g., object 117 in the frame corresponding to time t1 in FIG. 1B, and object 113 in the frame corresponding to time t2 in FIG. 1B) and in the current frame (e.g., object 115 in the frame corresponding to time tn of FIG. 1B) may be included in the captured video, e.g., with a certain amount of margin or range around bounding boxes of (or other indications of the location and/or identity of) such objects.

At 1014, the control circuitry may identify a location of the particular object (e.g., object 105 in FIG. 1A) as the target location in the environment (e.g., environment 100 of FIG. 1A). For example, based on the current location of such object, which may be tracked across frames of the video using segmentation and/or machine learning techniques, coordinates of object 105 of FIG. 1A in the current frame may be identified as the target location. In some embodiments, based on a context or subject matter of the scene being captured (e.g., a soccer game), the control circuitry may include an object (e.g., soccer ball 119 of FIG. 1) that is relevant to such scene (and is being dribbled by athlete 105 or otherwise) as part of the target location. At 1016, the control circuitry may adjust the capture direction of the camera (e.g., camera 106 of FIGS. 1A-1B) using the camera direction control element (e.g., MEMS scanning mirror 216 of FIG. 2) based on the determined target location in the environment. For example, as shown in FIG. 1B, based on the computed weighted center of the target locations in the frames corresponding to time t1, time t2, . . . time tn, the control circuitry may identify target viewing location 145. The control circuitry may adjust the tilt and/or pan angle of MEMS scanning mirror 216 to cause the capture direction of camera 106 to include and/or be focused at target viewing location 145. In the example of FIG. 1A, the control circuitry may adjust the tilt and/or pan angle of MEMS scanning mirror 216 to cause the capture direction of camera 106 to include and/or be focused on object 105. In some embodiments, the control circuitry may store a table of suitable pan and tilt angles for MEMS scanning mirror 216, for given coordinates of the camera in relation to coordinates associated with a target capture direction in the environment.

In some embodiments, a desired zoom and/or a desired capture direction may be determined using a machine learning model (e.g., machine learning model 300 of FIG. 3) which may be trained to accept as input data comprising one or more detected gaze angles of the user over a plurality of frames (e.g., captured at times t1, . . . tn of FIG. 1A or captured at times t1, t2, . . . tn of FIG. 1B) of the video and images corresponding to the plurality of frames of the first video. Such machine learning model may be configured to output, based on the input to the trained machine learning model, a desired zoom of the camera and a desired capture direction of the camera, e.g., target viewing direction 145 and target zoom level 126 of FIG. 1B.

At 1018, the control circuitry may adjust the zoom of the camera using the camera zoom control element (e.g., liquid lens 212 of FIG. 2) based on the determined target location in the environment. For example, as shown in FIG. 1B, the control circuitry may set target zoom level 126, which includes each of the identified target objects 117, 113, and 115 over the frames corresponding to times t1, t2, and tn. In some embodiments, the adjusted zoom of the camera and/or the adjusted capture direction may be set based on graphical indicator 143 surrounding each of the identified target objects 117, 113, and 115 or any suitable combination thereof. The control circuitry may be configured to determine a current zoom setting and a current capture direction of the camera, compare such current zoom setting and current capture direction to the desired zoom and capture direction, and determine how to adjust the zoom and capture direction based on such comparison.

At 1020, the control circuitry may cause the camera (e.g., camera 106) of the head-mounted computing device (e.g., computing device 104) to capture a video (e.g., the second video indicated at 114 of FIG. 1A or 124 of FIG. 1B) based on the adjusted zoom performed at 1018 and the adjusted capture direction performed at 1016. At 1022, the control circuitry may determine whether to stop capturing the video, e.g., based on received user input of the user or based on the video having been captured for a particular period of time. If so, processing may proceed to 1024; otherwise, processing may return to 1008 to continuously identify target locations in the captured video and update the adjusted zoom and/or adjusted capture direction if the target location is changed. At 1024, the captured video may be stored (e.g., at storage 808 of computing device 800 of FIG. 8, or at storage 914 of server 904 or database 905 of FIG. 9) or transmitted (e.g., via communication network 909 of FIG. 9) to another computing device or server or other user and/or posted on a webpage or other application and/or live streamed.

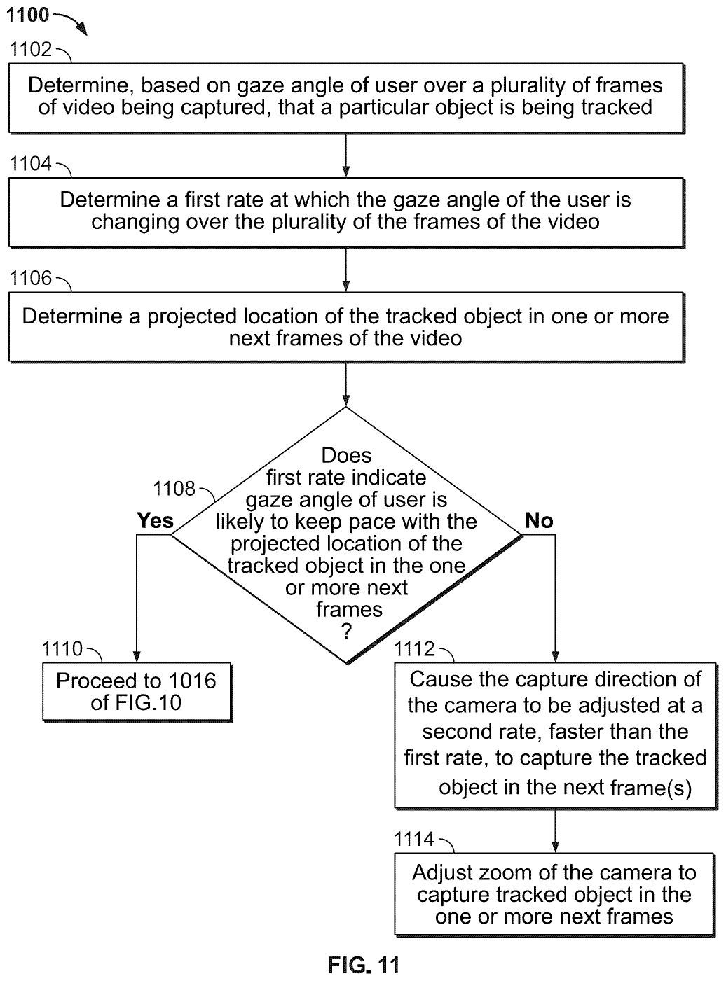

FIG. 11 is a flowchart of a detailed illustrative process for adjusting a rate of change of a capture direction based on a projected location of a tracked object, in accordance with some embodiments of this disclosure. In various embodiments, the individual steps of process 1100 may be implemented by one or more components of the computing devices, processes, and systems of FIGS. 1-10 and may be performed in combination with any of the other processes and aspects described herein. Although the present disclosure may describe certain steps of process 1100 (and of other processes described herein) as being implemented by certain components of the computing devices, processes, and systems of FIGS. 1-10, this is for purposes of illustration only. It should be understood that other components of the computing devices, processes, and systems of FIGS. 1-10 may implement those steps instead.

At 1102, I/O circuitry (e.g., I/O circuitry 802 of computing device 800 of FIG. 8 and/or I/O circuitry 912 of server 904 of FIG. 9) and/or control circuitry (e.g., control circuitry 804 of computing device 800 of FIG. 8 and/or control circuitry 911 of server 904 of FIG. 9) may determine, based on detected gaze angle(s) of a user over a plurality of frames of video being captured, that a particular object is being tracked. For example, 1102 may be performed in a similar manner to 1006, 1008, 1010, 1012, and/or 1014, to determine that a gaze angle of user 602 of FIG. 6 (e.g., represented by the solid lines extending from computing device 604 of FIG. 6) has exclusively or primarily (e.g., over 50% of the captured frames) focused on soccer ball 609 of FIG. 6, to determine that such soccer ball 609 is being tracked by user 602.

At 1104, the control circuitry may determine a first rate at which the gaze angle of the user (e.g., user 602 of FIG. 6) is changing over the plurality of the frames of the video. For example, the control circuitry may compare the gaze angle (represented by the solid lines extending from computing device 604) at time t1 of FIG. 6, to the gaze angle (represented by the solid lines extending from computing device 604) at time t2 of FIG. 6 (and/or to detected gaze angles at any other suitable number of frames), to determine such first rate, e.g., a rate of change of the gaze angle over time in relation to user 602 viewing environment 600.

At 1106, the control circuitry may determine a projected location of the tracked object in one or more next frames of the video. For example, the control circuitry may determine a projected path of the tracked object of interest (e.g., soccer ball 609) by comparing the location of soccer ball 609 in the frame at time t1 to the location of soccer ball 609 in the frame at time t2, to determine a vector representing the magnitude and direction of the motion of soccer ball 609.

At 1108, the control circuitry may determine whether the first rate determined at 1104 indicates that the gaze angle of user is likely to keep pace with the projected location of the tracked object in the one or more next frames. For example, based on the motion vector determined at 1106, control circuitry may project that a location of the object of interest (e.g., soccer ball 609 of FIG. 6) at time t3 is likely to correspond to a location of goalie 611 and/or the goal that goalie 611 is defending. The control circuitry may determine whether the gaze angle of user 602 is likely to shift to include the coordinates of such goalie 611 and/or goal at time t3, based on the first rate of the user's gaze angle determined at 1104. If yes, processing may proceed to 1110, which may correspond to 1016 of FIG. 10. Otherwise, processing may proceed to 1112.

At 1112, the control circuitry may determine a second rate, faster than the first rate, at which the capture direction of the camera should be adjusted to capture the tracked object in the one or more next frames. For example, such second rate may be calculated to adjust the capture direction of the camera (e.g., camera 606 of FIG. 6) such that the projected location of soccer ball 609 (e.g., near the goal and goalie 611) is included in the frame(s) captured at time t3 of FIG. 6. Thus, as shown by the dotted lines of time t3 of FIG. 6 indicating the capture direction has been adjusted at 607 using the camera direction control element (e.g., MEMS scanning mirror 216 of FIG. 2), the goalie's saving of soccer ball 609 at time t3 of FIG. 6 may be included in the video captured by camera 606, even if a gaze of the user at time t3 (represented by the solid lines extending from computing device 604) is lagging behind the target location, e.g., due to the speed of a particular object corresponding to the target location.

At 1114, the control circuitry may adjust the zoom of the camera (e.g., camera 606 of FIG. 6) to capture the tracked object (e.g., soccer ball 609) in the one or more next frames. For example, the control circuitry may use the camera zoom control element (e.g., liquid lens 210 of FIG. 2) to adjust the zoom to further zoom in on (and capture enhanced detail of) goalie 611 saving soccer ball 609. In some embodiments, the zoom may be adjusted to include other relevant objects in the captured video, e.g., player 605 having kicked soccer ball 609 towards goalie 611 with the shot on goal. In some circumstances, the control circuitry may cause the zoom level to be decreased, e.g., to zoom out of the scene, depending on a projected location of soccer ball 609 and/or other objects, to include relevant objects in the captured frame.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method, comprising:
causing a camera of a head-mounted computing device to capture a first video of an environment, wherein the head-mounted computing device comprises:
a camera direction control element for controlling a capture direction of the camera; and
a camera zoom control element for controlling zoom of the camera;
detecting a gaze angle of a user wearing the head-mounted computing device;
identifying, based on the detected gaze angle, one or more objects in the captured first video;
determining, based on the identified one or more objects, a target location in the environment;
adjusting the capture direction of the camera using the camera direction control element based on the determined target location in the environment;
adjusting the zoom of the camera using the camera zoom control element based on the determined target location in the environment; and
causing the camera to capture a second video using the camera of the head-mounted computing device, wherein the second video is captured based on the adjusted capture direction and the adjusted zoom of the camera.

2. The method of claim 1, wherein the camera direction control element comprises a microelectromechanical systems (MEMS) scanning mirror, and adjusting the capture direction of the camera using the camera direction control element comprises modifying an orientation of the MEMS scanning mirror.

3. The method of claim 1, wherein the camera zoom control element comprises a liquid lens, and adjusting the zoom of the camera using the camera zoom control element comprises applying an electrical signal to the liquid lens.

4. The method of claim 1, wherein:
adjusting the capture direction of the camera using the camera direction control element is performed without receiving a direct user request to modify the camera direction; and
adjusting the zoom of the camera using the camera zoom control element is performed without receiving a direct user request to modify the zoom of the camera.

5. The method of claim 1, wherein determining, based on the identified one or more objects, the target location in the environment comprises:
determining that the gaze angle indicates that a gaze of the user is directed at a particular object of the identified one or more objects over a plurality of frames of the first video; and
identifying a location of the particular object as the target location.

6. The method of claim 5, further comprising:
determining a first rate at which the gaze of the user is changing while tracking the particular object over the plurality of frames; and
determining a projected location of the particular object in a next frame of the first video,
wherein adjusting the capture direction of the camera using the camera direction control element based on the determined target location in the environment comprises causing the capture direction of the camera to be adjusted at a second rate that is faster than the first rate based on the projected location.

7. The method of claim 1, wherein determining, based on the identified one or more objects, the target location in the environment comprises:
determining that the gaze angle indicates that a gaze of the user is directed at different objects of the identified one or more objects over a plurality of frames of the first video;
assigning a first weight to pixels of a first object of the different objects in a first frame of the plurality of frames;
assigning a second weight to pixels of a second object of the different objects in a second frame of the plurality of frames, wherein the second frame is more recently captured than the first frame, and the second weight is higher than the first weight;
computing a weighted center point in the environment based on the gaze of the user over the plurality of frames of the first video, based on the first weight of the first frame and the second weight of the second frame; and
identifying the weighted center point as the target location.

8. The method of claim 1, wherein:
the capture direction of the camera is initially set to correspond to the detected gaze angle; and
the zoom of the camera is initially set to a predefined zoom level.

9. The method of claim 1, further comprising:
inputting, to a trained machine learning model, data comprising one or more detected gaze angles of the user over a plurality of frames of the first video and images corresponding to the plurality of frames of the first video; and
receiving as output from the trained machine learning model, based on the input to the trained machine learning model, a desired zoom of the camera and a desired capture direction of the camera,
wherein adjusting the zoom of the camera is performed based on the desired zoom of the camera, and adjusting the capture direction of the camera is performed based on the desired capture direction of the camera.

10. The method of claim 1, wherein the head-mounted computing device further comprises a beam splitter, the method further comprising:
using the beam splitter to cause an optical center of the camera to correspond to a position of an eye of the user, to enable determining the adjusted capture direction based on the detected gaze angle.

11. The method of claim 1, wherein adjusting the capture direction of the camera further comprises:
determining an intersection point of respective viewing directions of the eyes of the user; and
computing the adjusted capture direction based at least in part on the intersection point.

12. The method of claim 1, further comprising:
generating for display at the head-mounted computing device a graphical indicator that indicates a portion of the environment at which the detected gaze angle of the user is associated with in the captured second video, wherein the portion of the environment comprises the target location and a predefined portion of the environment around the target location; and
in response to determining that the zoom of the camera has reached a digital zoom beyond an optical zoom limit, modifying the display of the graphical indicator.

13. The method of claim 12, further comprising:
modifying the zoom of the camera based on detecting a change in the gaze angle of the user or based on detecting that the gaze angle indicates that a gaze of the user has been directed at a particular portion of the environment for at least a threshold period of time.

14. The method of claim 1, further comprising:
causing at least one of the first video or the second video to be captured in response to detecting a particular blink pattern of an eye of the user.

15. The method of claim 1, further comprising:
determining that the first video depicts a particular type of subject matter,
wherein each of adjusting the capture direction, and adjusting the zoom of the camera, is performed based at least in part on determining that the first video depicts the particular type of subject matter.

16. A head-mounted computing device, comprising:
a camera;
a camera direction control element for controlling a capture direction of the camera;
a camera zoom control element for controlling zoom of the camera; and
control circuitry configured to:
cause the camera to capture a first video of an environment;
detect a gaze angle of a user wearing the head-mounted computing device;
identify, based on the gaze angle of the user, one or more objects in the captured first video;
determine, based on the identified one or more objects, a target location in the environment;
adjust the capture direction of the camera using the camera direction control element based on the determined target location in the environment;
adjust the zoom of the camera using the camera zoom control element based on the determined target location in the environment; and
cause the camera to capture a second video using the camera of the head-mounted computing device, wherein the second video is captured based on the adjusted capture direction and the adjusted zoom of the camera.

17. The head-mounted computing device of claim 16, wherein the camera direction control element comprises a microelectromechanical systems (MEMS) scanning mirror, and the control circuitry is configured to adjust the capture direction of the camera using the camera direction control element by modifying an orientation of the MEMS scanning mirror.

18. The head-mounted computing device of claim 16, wherein the camera zoom control element comprises a liquid lens, and the control circuitry is configured to adjust the zoom of the camera using the camera zoom control element by causing an electrical signal to be applied to the liquid lens.

19. The head-mounted computing device of claim 16, wherein:
the control circuitry is configured to adjust the capture direction of the camera using the camera direction control element without receiving a direct user request to modify the camera direction; and
the control circuitry is configured to adjust the zoom of the camera using the camera zoom control element without receiving a direct user request to modify the zoom of the camera.

20. The head-mounted computing device of claim 16, wherein the control circuitry is configured to determine, based on the identified one or more objects, the target location in the environment by:
determining that the gaze angle indicates that a gaze of the user is directed at a particular object of the identified one or more objects over a plurality of frames of the first video; and
identifying a location of the particular object as the target location.

21-75. (canceled)
